(19) United States
(12) Patent Application Publication
(10) Pub. No.: US 2025/0342121 A1
(43) Pub. Date: Nov. 6, 2025

(54) VARIABLE CACHELINE SET MAPPING

(71) Applicant: Intel Corporation, Santa Clara, CA (US)

(72) Inventors: Kshitij Arun Doshi, Tempe, AZ (US); Pujiang He, Shanghai (CN)

(73) Assignee: Intel Corporation, Santa Clara, CA (US)

(21) Appl. No.: 18/868,623

(22) PCT Filed: Jun. 30, 2022
(86) PCT No.: PCT/CN2022/102702

§ 371 Date: Nov. 22, 2024

(51) Int. Cl. G06F 12/0864; G06F 12/1009

(52) U.S. Cl. CPC G06F 12/0864; G06F 12/1009; G06F 2212/6032

(57) ABSTRACT

Techniques for variable mapping are described. An example apparatus comprises a memory and circuitry coupled to the memory to map an index to a particular set of one or more sets based on an indicated map function of two or more map functions, and lookup an entry in the memory based at least in part on the particular set indicated by the mapped index. Other examples are disclosed and claimed.

### BACKGROUND

A multi-way set associative cache provides multiple blocks for each set where data mapped to that set might be found. For example, an N-way set associative cache provides N blocks in each set (where N is sometimes referred to as the degree of associativity of the cache). Each memory address still maps to a specific set, but the address can map to any one of the N blocks in the set. A way may include a data block, tag bits, and a valid bit. The cache reads blocks from the N-ways in a selected set and checks the tags and valid bits for a hit. If a hit occurs in one of the ways, data is selected from that way. An address may be divided into sections, one of which corresponds to an index. For an n-way set-associative cache, a set includes one block per way, all of which share the same index.

### BRIEF DESCRIPTION OF DRAWINGS

Various examples in accordance with the present disclosure will be described with reference to the drawings, in which:

FIG. 1A is a block diagram of an example of an apparatus that includes variable mapping technology in one implementation.

FIGS. 1B to 1C are illustrative diagrams of an example of a method in one implementation of variable mapping technology.

FIG. 2A is a block diagram of an example of another apparatus that includes variable mapping technology in one implementation.

FIGS. 2B to 2C are illustrative diagrams of another example of a method in one implementation of variable mapping technology.

FIG. 3A is a block diagram of another example of an apparatus that includes variable mapping technology in one implementation.

FIGS. 3B to 3D are illustrative diagrams of another example of a method in one implementation of variable mapping technology.

FIG. 4 is a block diagram of an example of a processor that includes variable mapping technology in one implementation.

FIG. 5 is a block diagram of an example of a cache agent that includes variable mapping technology in one implementation.

FIG. 6 is an illustrative diagram of an example of a mesh network comprising cache agents that include variable mapping technology in one implementation.

FIG. 7 is an illustrative diagram of an example of a ring network comprising cache agents that include variable mapping technology in one implementation.

FIG. 8 is a block diagram of an example of a cache home agent that includes variable mapping technology in one implementation.

FIG. 9 is a block diagram of an example of a system on a chip that includes variable mapping technology in one implementation.

FIG. 10 is a block diagram of an example of a system that includes variable mapping technology in one implementation.

FIG. 11 is an illustrative diagram of an example of a server that includes variable mapping technology in one implementation.

FIG. 12A is an illustrative diagram of an example of memory access circuitry that includes variable mapping technology in one implementation.

FIG. 12B is an illustrative diagram of an example of a computing system that includes variable mapping technology in one implementation.

FIG. 12C is an illustrative diagram of examples of mapping options for variable mapping technology in one implementation.

FIG. 12D is an illustrative diagram of another example of a computing system that includes variable mapping technology in one implementation.

FIG. 13A is an illustrative diagram of an example of an integrated circuit with mean residency time tracking technology in one implementation.

FIG. 13B is an illustrative diagram of an example of method in one implementation of tracking mean residency time.

FIG. 13C is an illustrative diagram of an example of a processor that includes mean residency time tracking technology in one implementation.

FIG. 14 illustrates an exemplary system.

FIG. 15 illustrates a block diagram of an example processor that may have more than one core and an integrated memory controller.

FIG. 16A is a block diagram illustrating both an exemplary in-order pipeline and an exemplary register renaming, out-of-order issue/execution pipeline according to examples.

FIG. 16B is a block diagram illustrating both an exemplary example of an in-order architecture core and an exemplary register renaming, out-of-order issue/execution architecture core to be included in a processor according to examples.

FIG. 17 illustrates examples of execution unit(s) circuitry.

FIG. 18 is a block diagram of a register architecture according to some examples.

FIG. 19 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for variable mapping technology for set associative caches. According to some examples, the technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide variable cacheline set mapping.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up-i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some implementations provide technology for variable cacheline set mapping. Conventionally, multiple core processors/systems may employ some form of fixed cacheline set mapping. Cache management for processors has substantially increased in complexity over previous processor generations. Advances according to Moore's law have resulted in processors being able to host significantly more complex functionality integrated on a single die. This includes significant increases in core count, cache sizes, memory channels, and external interfaces (e.g., chip-to-chip coherent links and I/O links) as well as significantly more advanced reliability, security, and power management algorithms. This increase in microarchitectural complexity has not been matched with corresponding improvements in cacheline set mapping technology. Accordingly, fixed cacheline set mapping may cause both application and workload performance to suffer. This problem particularly affects matrix operations and other complex applications where strided memory access patterns may become cache bound due to limitations in the fixed cacheline set mapping techniques and the resources allotted to cache management.

Moreover, given transitions towards a full System-On-Chip (SoC) development model for processors (e.g., server processors), supporting a larger number of SoCs (including many product derivatives) with improved cacheline set mapping is advantageous. Some implementations may address or overcome one or more of the foregoing problems.

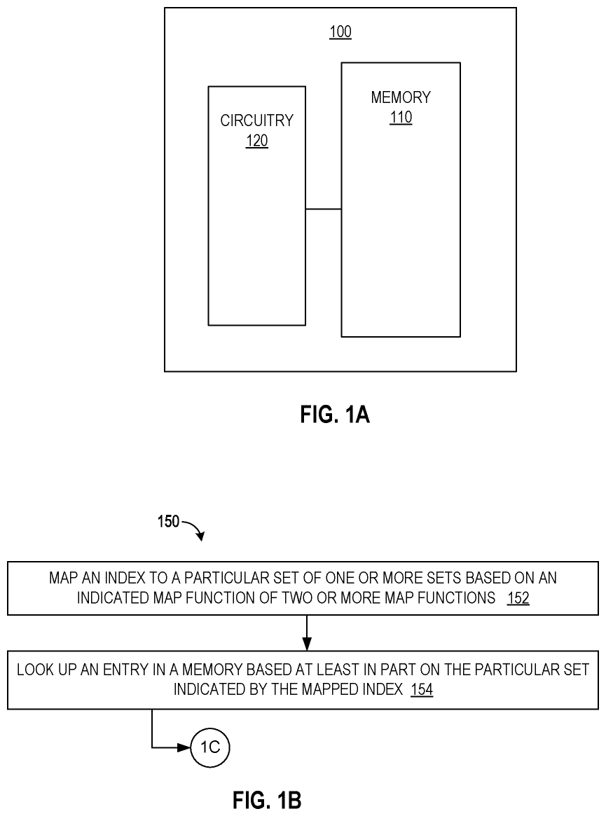

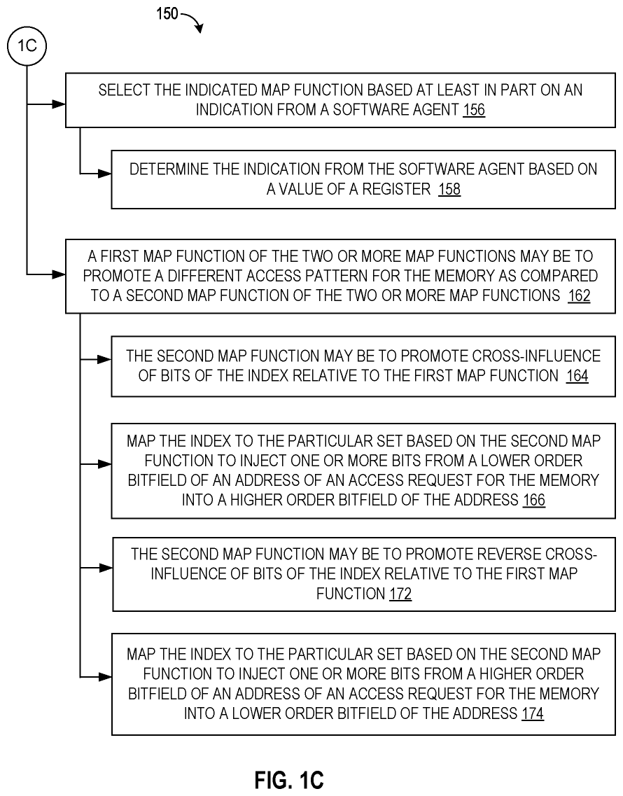

FIG. 1A shows an example of an apparatus 100 comprising a memory 110, and circuitry 120 coupled to the memory 110 to map an index to a particular set of one or more sets based on an indicated map function of two or more map functions, and lookup an entry in the memory 110 based at least in part on the particular set indicated by the mapped index. For example, the circuitry 120 may be configured to select the indicated map function based at least in part on an indication from a software agent. In some examples, the circuitry 120 may be further configured to determine the indication from the software agent based on a value of a register (e.g., a control register, a configuration register, a model specific register (MSR), etc.).

In some examples, a first map function of the two or more map functions may be configured to promote a different access pattern for the memory 110 as compared to a second map function of the two or more map functions. In one example, the second map function may be configured to promote cross-influence of bits of the index relative to the first map function. For example, the circuitry 120 may be configured to map the index to the particular set based on the second map function to inject one or more bits from a lower order bitfield of an address of an access request for the memory 110 into a higher order bitfield of the address. In another example, the second map function is to promote reverse cross-influence of bits of the index relative to the first map function. For example, the circuitry 120 may be configured to map the index to the particular set based on the second map function to inject one or more bits from a higher order bitfield of an address of an access request for the memory 110 into a lower order bitfield of the address.

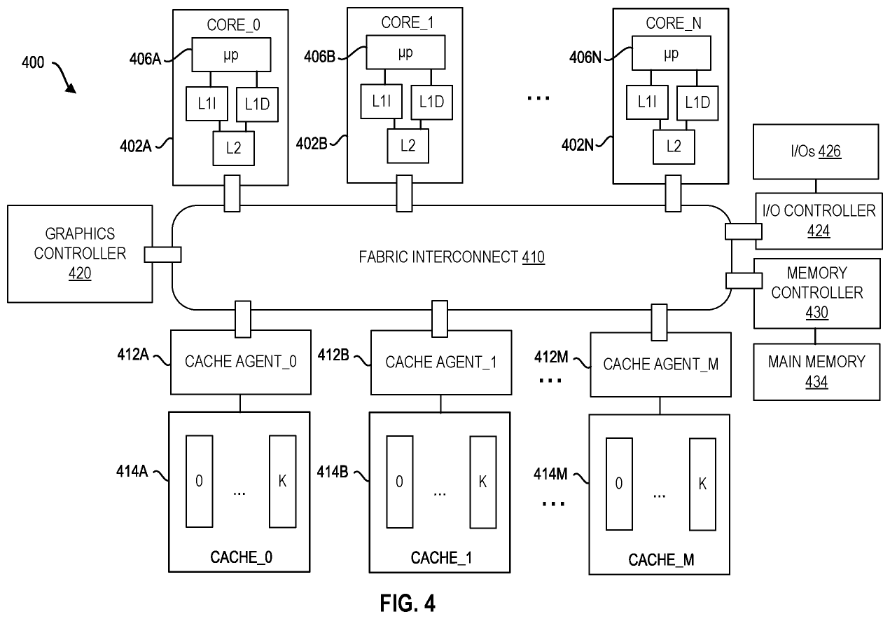

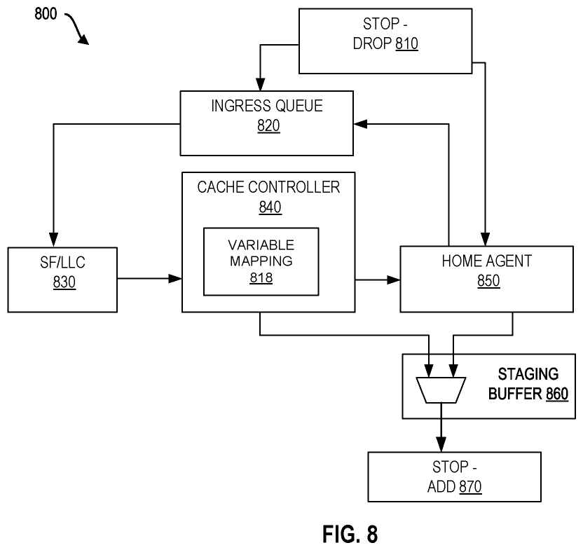

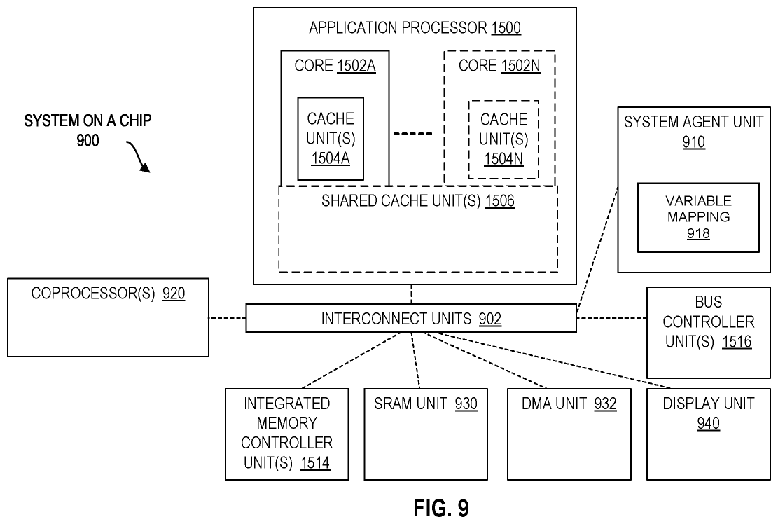

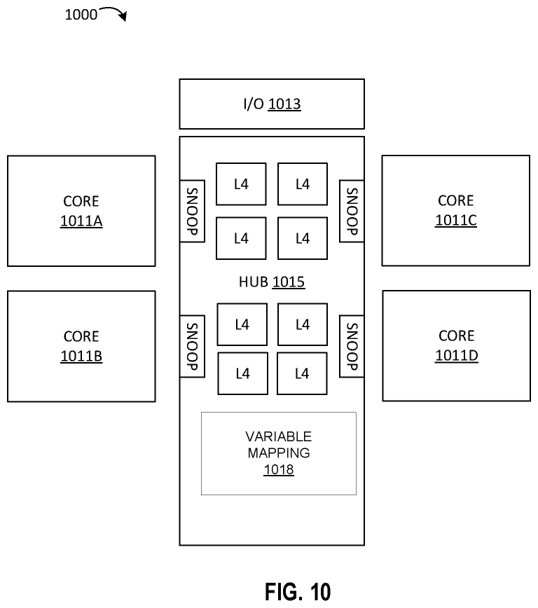

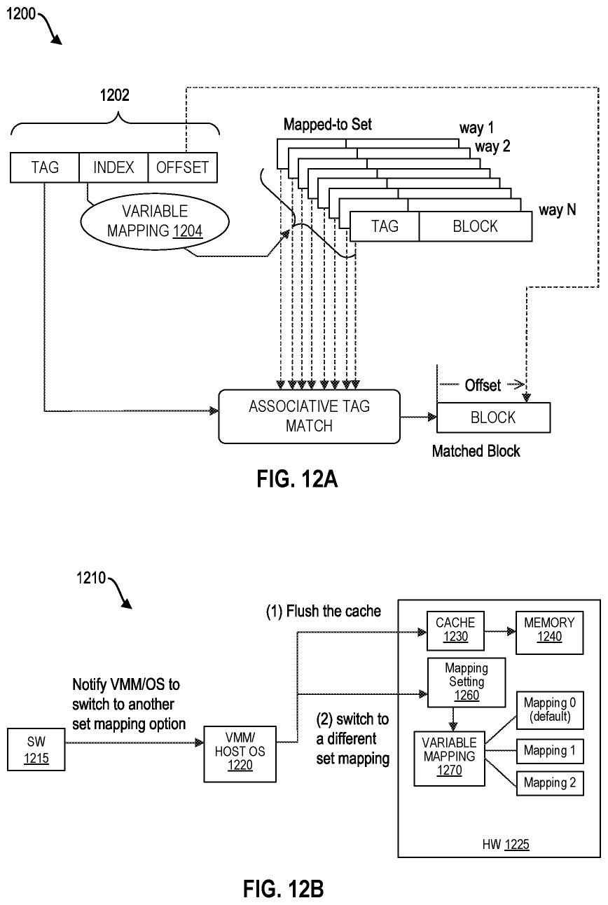

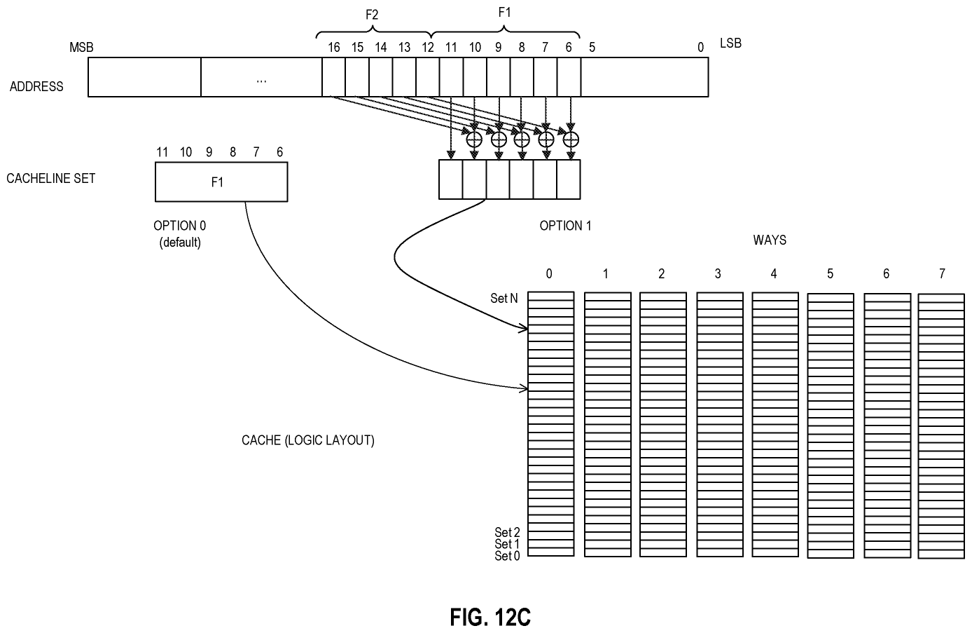

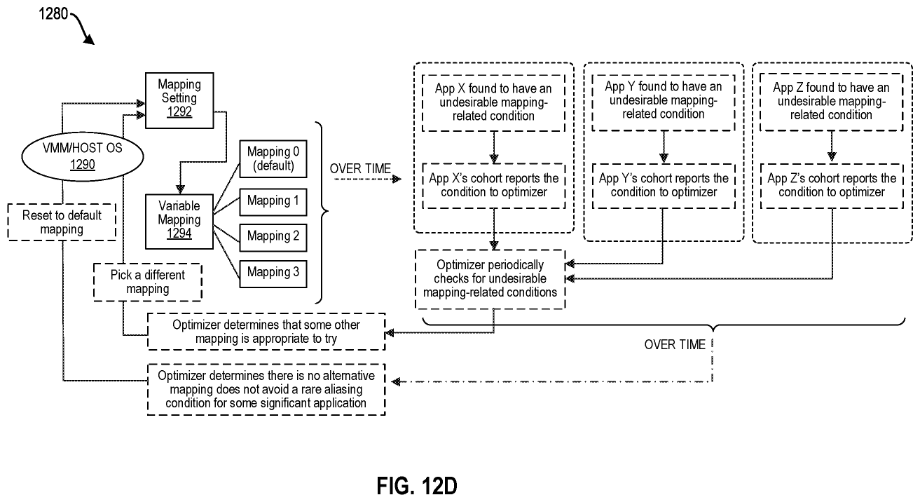

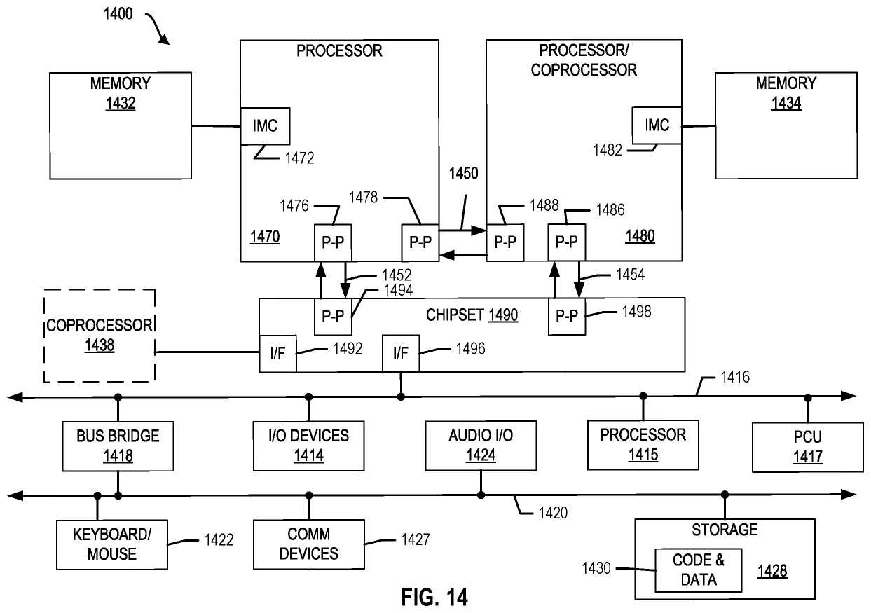

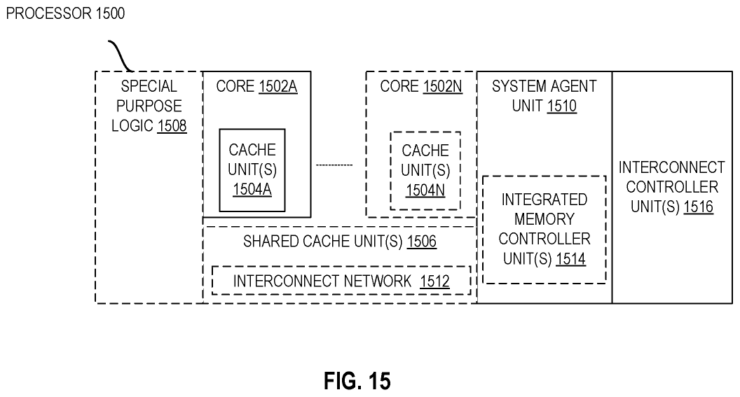

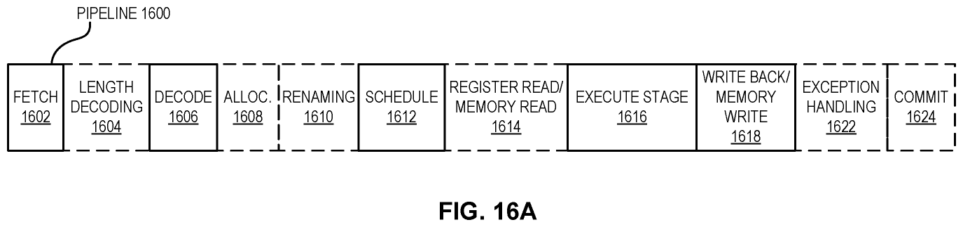

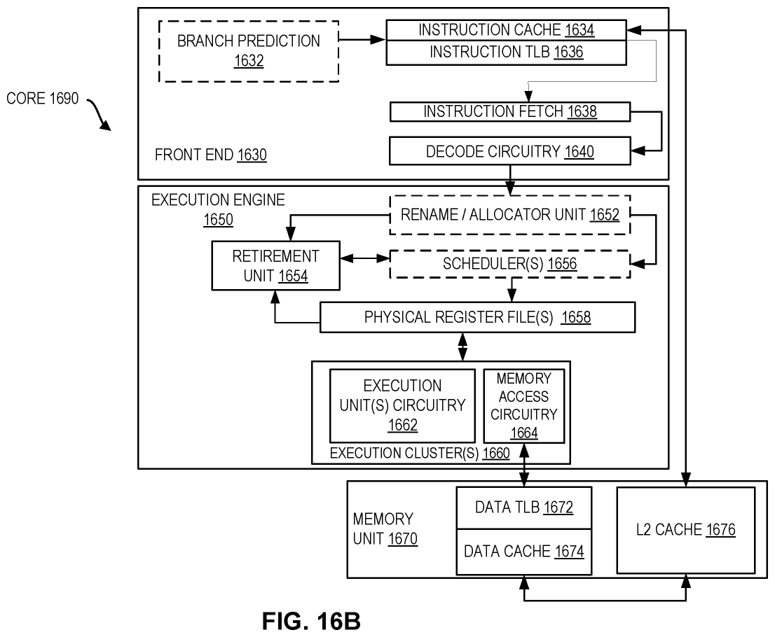

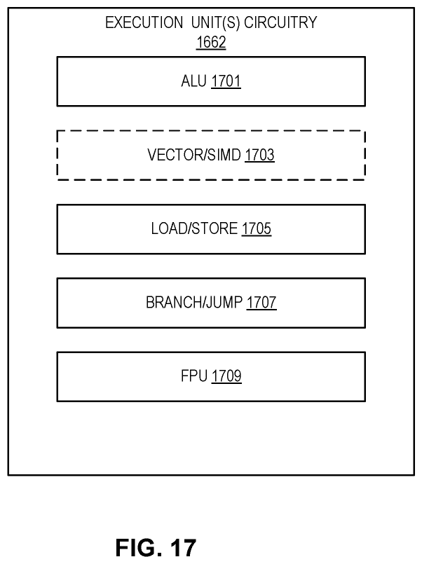

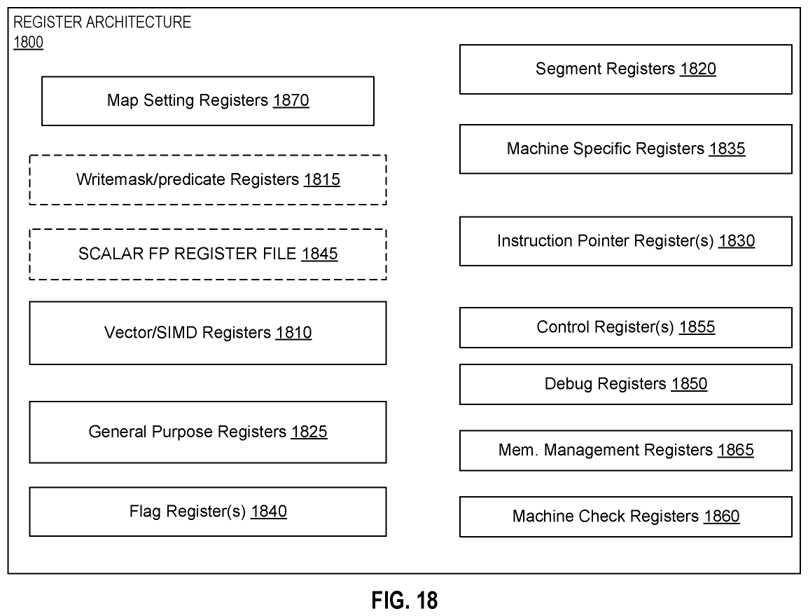

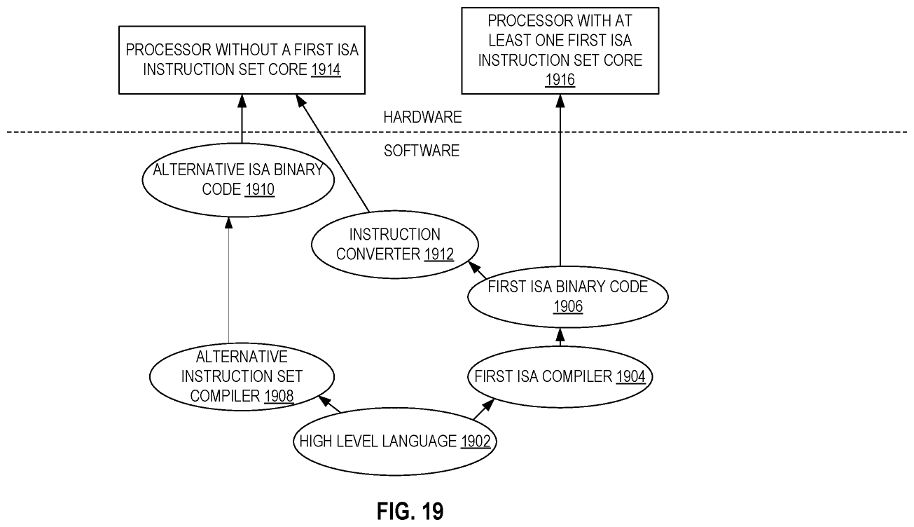

For example, the circuitry 120 may be incorporated in any of the processors/systems described herein. In some examples, the circuitry 120 may be incorporated in the processor 400 (FIG. 4), the memory access circuitry 1200, the system 1210, the system 1280 (FIGS. 12A to 12D), processor 1400, the processor 1470, the processor 1415, the coprocessor 1438, the processor/coprocessor 1480 (FIG. 14), the processor 1500 (FIG. 15), the core 1690 (FIG. 16B), the execution units 1662 (FIGS. 16B and 17), and the processor 1916 (FIG. 19). In particular, the circuitry 120 may be integrated as part of a memory/cache subsystem and/or with the cache agent 412 (FIGS. 4 to 7), the cache home agent 800 (FIG. 8), the system agent unit 910 (FIG. 9), the hub 1015 (FIG. 10), and the system agent 1510 (FIG. 15). In some examples, the apparatus 100 may include or be communicatively coupled to map setting registers 1870 (FIG. 18).

FIGS. 1B to 1C show an example of a method 150 comprising mapping an index to a particular set of one or more sets based on an indicated map function of two or more map functions at 152, and looking up an entry in a memory based at least in part on the particular set indicated by the mapped index at 154. In some examples, the method 150 may further include selecting the indicated map function based at least in part on an indication from a software agent at 156. For example, the method 150 may include determining the indication from the software agent based on a value of a register at 158.

In some examples, a first map function of the two or more map functions may be to promote a different access pattern for the memory as compared to a second map function of the two or more map functions at 162. In one example, the second map function may be to promote cross-influence of bits of the index relative to the first map function at 164. For example, the method 150 may include mapping the index to the particular set based on the second map function to inject one or more bits from a lower order bitfield of an address of an access request for the memory into a higher order bitfield of the address at 166. In another example, the second map function may be to promote reverse cross-influence of bits of the index relative to the first map function at 172. For example, the method 150 may include mapping the index to the particular set based on the second map function to inject one or more bits from a higher order bitfield of an address of an access request for the memory into a lower order bitfield of the address at 174.

For example, the method 150 may be performed by any of the processors/systems described herein. In some examples, one or more aspects of the method 150 may be performed by the processor 400 (FIG. 4), the memory access circuitry 1200, the system 1210, the system 1280 (FIGS. 12A to 12D), processor 1400, the processor 1470, the processor 1415, the coprocessor 1438, the processor/coprocessor 1480 (FIG. 14), the processor 1500 (FIG. 15), the core 1690 (FIG. 16B), the execution units 1662 (FIGS. 16B and 17), and the processor 1916 (FIG. 19). In particular, the method 150 may be performed by a memory/cache subsystem and/or with the cache agent 412 (FIGS. 4 to 7), the cache home agent 800 (FIG. 8), the system agent unit 910 (FIG. 9), the hub 1015 (FIG. 10), and the system agent 1510 (FIG. 15).

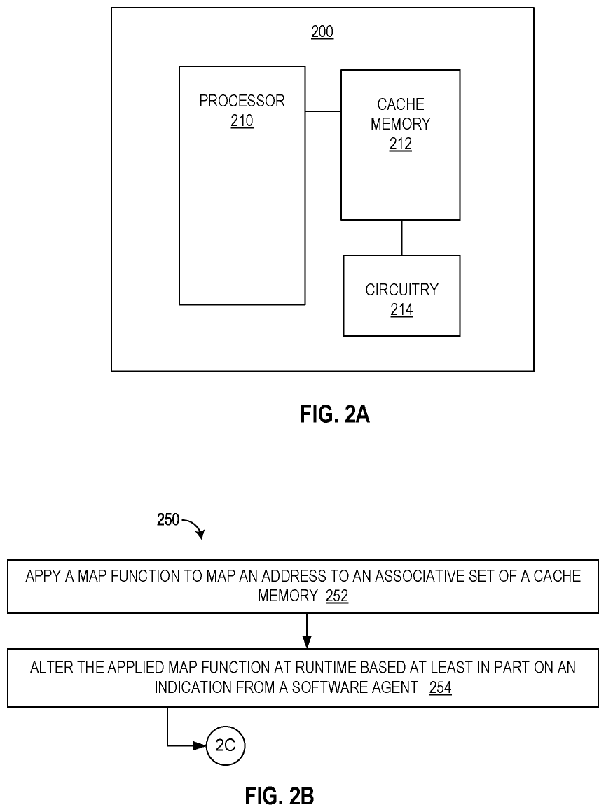

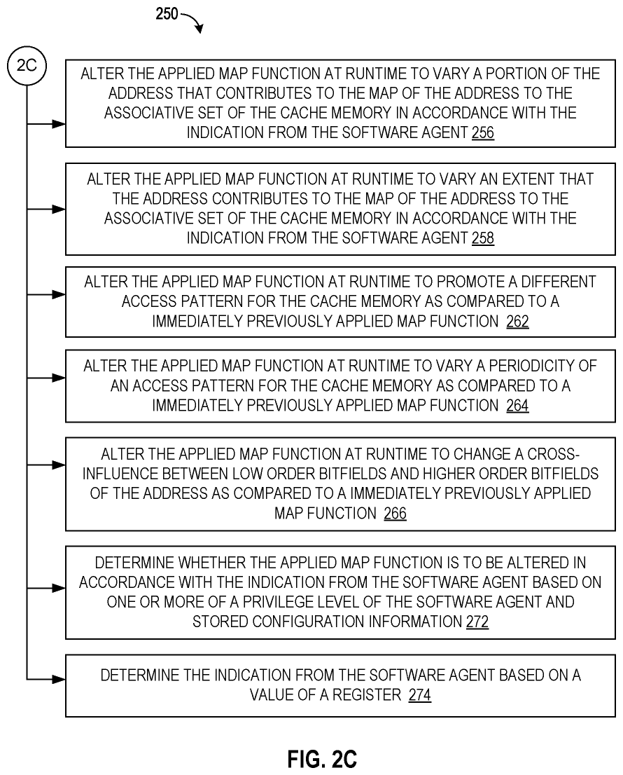

FIG. 2A shows an example of an apparatus 200 comprising a processor 210, a cache memory 212 coupled to the processor 210, and circuitry 214 coupled to the cache memory 212 to apply a map function to map an address to an associative set of the cache memory 212, and alter the applied map function at runtime based at least in part on an indication from a software agent. In one example, the circuitry 214 may be configured to alter the applied map function at runtime to vary a portion of the address that contributes to the map of the address to the associative set of the cache memory 212 in accordance with the indication from the software agent. In another example, the circuitry 214 may be additionally or alternatively configured to alter the applied map function at runtime to vary an extent that the address contributes to the map of the address to the associative set of the cache memory 212 in accordance with the indication from the software agent.

In some examples, the circuitry 214 may be additionally or alternatively configured to alter the applied map function at runtime to promote a different access pattern for the cache memory 212 as compared to an immediately previously applied map function. In one example, the circuitry 214 may be additionally or alternatively configured to alter the applied map function at runtime to vary a periodicity of an access pattern for the cache memory as compared to an immediately previously applied map function. In another example, the circuitry 214 may be additionally or alternatively configured to alter the applied map function at runtime to change a cross-influence between low order bitfields and higher order bitfields of the address as compared to an immediately previously applied map function. In another example, the circuitry 214 may be additionally or alternatively configured to determine whether the applied map function is to be altered in accordance with the indication from the software agent based on one or more of a privilege level of the software agent and stored configuration information. In some examples, the circuitry 214 may be additionally or alternatively configured to determine the indication from the software agent based on a value of a register.

For example, the circuitry 214 may be incorporated in any of the processors/systems described herein. In some examples, the circuitry 214 may be incorporated in the processor 400 (FIG. 4), the memory access circuitry 1200, the system 1210, the system 1280 (FIGS. 12A to 12D), processor 1400, the processor 1470, the processor 1415, the coprocessor 1438, the processor/coprocessor 1480 (FIG. 14), the processor 1500 (FIG. 15), the core 1690 (FIG. 16B), the execution units 1662 (FIGS. 16B and 17), and the processor 1916 (FIG. 19). In particular, the circuitry 214 may be integrated as part of a memory/cache subsystem and/or with the cache agent 412 (FIGS. 4 to 7), the cache home agent 800 (FIG. 8), the system agent unit 910 (FIG. 9), the hub 1015 (FIG. 10), and the system agent 1510 (FIG. 15). In some examples, the apparatus 200 may include or be communicatively coupled to map setting registers 1870 (FIG. 18).

FIGS. 2B to 2C show an example of a method 250 comprising applying a map function to map an address to an associative set of a cache memory at 252, and altering the applied map function at runtime based at least in part on an indication from a software agent at 254. In one example, the method 250 may further include altering the applied map function at runtime to vary a portion of the address that contributes to the map of the address to the associative set of the cache memory in accordance with the indication from the software agent at 256. In another example, the method 250 may additionally or alternatively further include altering the applied map function at runtime to vary an extent that the address contributes to the map of the address to the associative set of the cache memory in accordance with the indication from the software agent at 258.

In some examples, the method 250 may additionally or alternatively further include altering the applied map function at runtime to promote a different access pattern for the cache memory as compared to an immediately previously applied map function at 262. In one example, the method 250 may additionally or alternatively further include altering the applied map function at runtime to vary a periodicity of an access pattern for the cache memory as compared to an immediately previously applied map function at 264. In another example, the method 250 may additionally or alternatively further include altering the applied map function at runtime to change a cross-influence between low order bitfields and higher order bitfields of the address as compared to an immediately previously applied map function at 266. In some examples, the method 250 may additionally or alternatively further include determining whether the applied map function is to be altered in accordance with the indication from the software agent based on one or more of a privilege level of the software agent and stored configuration information at 272. In some examples, the method 250 may additionally or alternatively further include determining the indication from the software agent based on a value of a register at 274.

For example, the method 250 may be performed by any of the processors/systems described herein. In some examples, one or more aspects of the method 250 may be performed by the processor 400 (FIG. 4), the memory access circuitry 1200, the system 1210, the system 1280 (FIGS. 12A to 12D), processor 1400, the processor 1470, the processor 1415, the coprocessor 1438, the processor/coprocessor 1480 (FIG. 14), the processor 1500 (FIG. 15), the core 1690 (FIG. 16B), the execution units 1662 (FIGS. 16B and 17), and the processor 1916 (FIG. 19). In particular, the method 250 may be performed by a memory/cache subsystem and/or with the cache agent 412 (FIGS. 4 to 7), the cache home agent 800 (FIG. 8), the system agent unit 910 (FIG. 9), the hub 1015 (FIG. 10), and the system agent 1510 (FIG. 15).

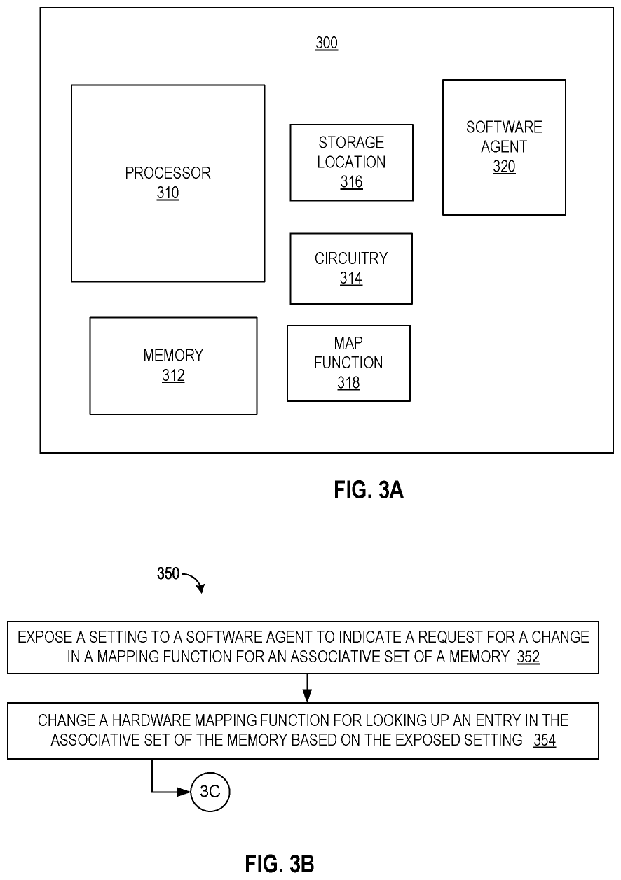

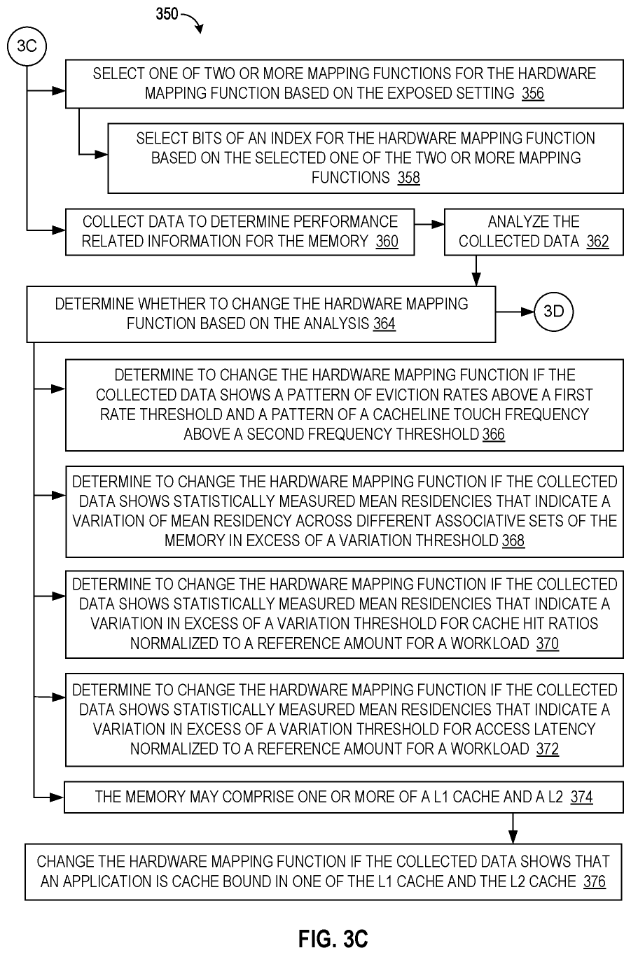

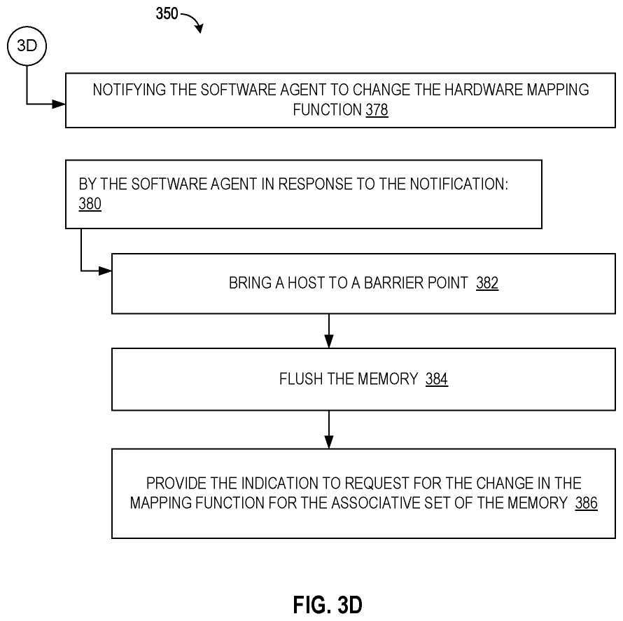

FIG. 3A shows an example of an apparatus 300 comprising a processor 310, memory 312 coupled to the processor 310, and circuitry 314 coupled to the memory 312 to expose a storage location 316 to a software agent 320 to indicate a request for a change in a map function for an associative set of the memory 312, and change a hardware map function 318 to lookup an entry in the associative set of the memory 312 based on a value stored in the storage location 316. For example, the circuitry 314 may be configured to select one of two or more map functions for the hardware map function 318 based on the value stored in the storage location 316, and to select bits of an index for the hardware map function 318 based on the selected one of the two or more map functions.

In some examples, the circuitry 314 may be further configured to collect data to determine performance related information for the memory 312, analyze the collected data, and determine if a performance of the memory 312 may be improved by a change to the hardware map function based on the analysis. In one example, the circuitry 314 may be configured to determine that the performance of the memory 312 may be improved by the change to the hardware map function if the collected data shows a pattern of eviction rates above a first rate threshold and a pattern of a cacheline touch frequency above a second frequency threshold. In another example, the circuitry 314 may be additionally or alternatively configured to determine that the performance of the memory 312 may be improved by the change to the hardware map function if the collected data shows statistically measured mean residencies that indicate a variation of mean residency across different associative sets of the memory 312 in excess of a variation threshold.

In another example, the circuitry 314 may be additionally or alternatively configured to determine that the performance of the memory may be improved by the change to the hardware map function if the collected data shows statistically measured mean residencies that indicate a variation in excess of a variation threshold for cache hit ratios normalized to a reference amount for a workload. In another example, the circuitry 314 may be additionally or alternatively configured to determine that the performance of the memory may be improved by the change to the hardware map function if the collected data shows statistically measured mean residencies that indicate a variation in excess of a variation threshold for access latency normalized to a reference amount for a workload. In some examples, the memory 312 may comprise one or more of a level one (L1) cache and a level two (L2), and the circuitry 314 may be additionally or alternatively configured to determine that the performance of the memory may be improved by the change to the hardware map function if the collected data shows that an application is cache bound in one of the L1 cache and the L2 cache.

In some examples, the circuitry 314 may be further configured to notify the software agent 320 that the performance of the memory may be improved by the change to the hardware map function, if so determined. In some examples, in response to the notification, the software agent 320 may be configured to bring a host to a barrier point, flush the memory 312, and provide the indication to request for the change in the map function for the associative set of the memory 312.

For example, the circuitry 314 may be incorporated in any of the processors/systems described herein. In some examples, the circuitry 314 may be incorporated in the processor 400 (FIG. 4), the memory access circuitry 1200, the system 1210, the system 1280 (FIGS. 12A to 12D), processor 1400, the processor 1470, the processor 1415, the coprocessor 1438, the processor/coprocessor 1480 (FIG. 14), the processor 1500 (FIG. 15), the core 1690 (FIG. 16B), the execution units 1662 (FIGS. 16B and 17), and the processor 1916 (FIG. 19). In particular, one or more aspects of the circuitry 314 may be integrated as part of a memory/cache subsystem and/or with the cache agent 412 (FIGS. 4 to 7), the cache home agent 800 (FIG. 8), the system agent unit 910 (FIG. 9), the hub 1015 (FIG. 10), and the system agent 1510 (FIG. 15). In some examples, the storage location 316 may be implemented by map setting registers 1870 (FIG. 18).

FIGS. 3B to 3D show an example of a method 350 comprising exposing a setting to a software agent to indicate a request for a change in a mapping function for an associative set of a memory at 352, and changing a hardware mapping function for looking up an entry in the associative set of the memory based on the exposed setting at 354. For example, the method 350 may include selecting one of two or more mapping functions for the hardware mapping function based on the exposed setting at 356, and selecting bits of an index for the hardware mapping function based on the selected one of the two or more mapping functions at 358.

Some examples of the method 350 may further include collecting data to determine performance related information for the memory at 360, analyzing the collected data at 362, and determining whether to change the hardware mapping function based on the analysis at 364. In one example, the method 350 may further include determining to change the hardware mapping function if the collected data shows a pattern of eviction rates above a first rate threshold and a pattern of a cacheline touch frequency above a second frequency threshold at 366. In another example, the method 350 may further include determining to change the hardware mapping function if the collected data shows statistically measured mean residencies that indicate a variation of mean residency across different associative sets of the memory in excess of a variation threshold at 368.

In another example, the method 350 may further include determining to change the hardware mapping function if the collected data shows statistically measured mean residencies that indicate a variation in excess of a variation threshold for cache hit ratios normalized to a reference amount for a workload at 370. In another example, the method 350 may further include determining to change the hardware mapping function if the collected data shows statistically measured mean residencies that indicate a variation in excess of a variation threshold for access latency normalized to a reference amount for a workload at 372. In some examples, the memory may comprise one or more of a L1 cache and a L2 at 374, and the method 350 may further include determining to change the hardware mapping function if the collected data shows that an application is cache bound in one of the L1 cache and the L2 cache at 376.

Some examples of the method 350 may further include notifying the software agent to change the hardware mapping function at 378, if so determined (e.g., at 364). For example, the method 350 may also include, by the software agent in response to the notification at 380, bringing a host to a barrier point at 382, flushing the memory at 384, and providing the indication to request for the change in the mapping function for the associative set of the memory at 386.

For example, the method 350 may be performed by any of the processors/systems described herein. In some examples, one or more aspects of the method 350 may be performed by the processor 400 (FIG. 4), the memory access circuitry 1200, the system 1210, the system 1280 (FIGS. 12A to 12D), processor 1400, the processor 1470, the processor 1415, the coprocessor 1438, the processor/coprocessor 1480 (FIG. 14), the processor 1500 (FIG. 15), the core 1690 (FIG. 16B), the execution units 1662 (FIGS. 16B and 17), and the processor 1916 (FIG. 19). In particular, one or more aspects of the method 350 may be performed by a memory/cache subsystem and/or with the cache agent 412 (FIGS. 4 to 7), the cache home agent 800 (FIG. 8), the system agent unit 910 (FIG. 9), the hub 1015 (FIG. 10), and the system agent 1510 (FIG. 15).

FIG. 4 is a block diagram of a processor 400 with a plurality of cache agents 412 and caches 414 in accordance with certain examples. In a particular example, processor 400 may be a single integrated circuit, though it is not limited thereto. The processor 400 may be part of a SoC in various examples. The processor 400 may include, for example, one or more cores 402A, 402B . . . 402N (collectively, cores 402). In a particular example, the cores 402 may include a corresponding microprocessor 406A, 406B, or 406N, level one instruction (L1I) cache, level one data cache (L1D), and level two (L2) cache. The processor 400 may further include one or more cache agents 412A, 412B . . . 412M (any of these cache agents may be referred to herein as cache agent 412), and corresponding caches 414A, 414B . . . 414M (any of these caches may be referred to as cache 414). In a particular example, a cache 414 is a last level cache (LLC) slice. An LLC may be made up of any suitable number of LLC slices. Each cache may include one or more banks of memory that corresponds (e.g., duplicates) data stored in system memory 434. The processor 400 may further include a fabric interconnect 410 comprising a communications bus (e.g., a ring or mesh network) through which the various components of the processor 400 connect. In one example, the processor 400 further includes a graphics controller 420, an I/O controller 424, and a memory controller 430. The I/O controller 424 may couple various I/O devices 426 to components of the processor 400 through the fabric interconnect 410. Memory controller 430 manages memory transactions to and from system memory 434.

The processor 400 may be any type of processor, including a general purpose microprocessor, special purpose processor, microcontroller, coprocessor, graphics processor, accelerator, field programmable gate array (FPGA), or other type of processor (e.g., any processor described herein). The processor 400 may include multiple threads and multiple execution cores, in any combination. In one example, the processor 400 is integrated in a single integrated circuit die having multiple hardware functional units (hereafter referred to as a multi-core system). The multi-core system may be a multi-core processor package, but may include other types of functional units in addition to processor cores. Functional hardware units may include processor cores, digital signal processors (DSP), image signal processors (ISP), graphics cores (also referred to as graphics units), voltage regulator (VR) phases, input/output (I/O) interfaces (e.g., serial links, DDR memory channels) and associated controllers, network controllers, fabric controllers, or any combination thereof.

System memory 434 stores instructions and/or data that are to be interpreted, executed, and/or otherwise used by the cores 402A, 402B . . . 402N. The cores 402 may be coupled towards the system memory 434 via the fabric interconnect 410. In some examples, the system memory 434 has a dual-inline memory module (DIMM) form factor or other suitable form factor.

The system memory 434 may include any type of volatile and/or non-volatile memory. Non-volatile memory is a storage medium that does not require power to maintain the state of data stored by the medium. Nonlimiting examples of non-volatile memory may include any or a combination of: solid state memory (such as planar or three-dimensional (3D) NAND flash memory or NOR flash memory), 3D crosspoint memory, byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), a memristor, phase change memory, Spin Hall Effect Magnetic RAM (SHE-MRAM), Spin Transfer Torque Magnetic RAM (STTRAM), or other non-volatile memory devices.

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory array is synchronous dynamic random access memory (SDRAM). In some examples, any portion of system memory 434 that is volatile memory can comply with JEDEC standards including but not limited to Double Data Rate (DDR) standards, e.g., DDR3, 4, and 5, or Low Power DDR4 (LPDDR4) as well as emerging standards.

A cache (e.g., cache 414) may include any type of volatile or non-volatile memory, including any of those listed above. Processor 400 is shown as having a multi-level cache architecture. In one example, the cache architecture includes an on-die or on-package L1 and L2 cache and an on-die or on-chip LLC (though in other examples the LLC may be off-die or off-chip) which may be shared among the cores 402A, 402B, . . . 402N, where requests from the cores are routed through the fabric interconnect 410 to a particular LLC slice (i.e., a particular cache 414) based on request address. Any number of cache configurations and cache sizes are contemplated. Depending on the architecture, the cache may be a single internal cache located on an integrated circuit or may be multiple levels of internal caches on the integrated circuit. Other examples include a combination of both internal and external caches depending on particular examples.

During operation, a core 402A, 402B . . . or 402N may send a memory request (read request or write request), via the L1 caches, to the L2 cache (and/or other mid-level cache positioned before the LLC). In one case, a memory controller 430 may intercept a read request from an L1 cache. If the read request hits the L2 cache, the L2 cache returns the data in the cache line that matches a tag lookup. If the read request misses the L2 cache, then the read request is forwarded to the LLC (or the next mid-level cache and eventually to the LLC if the read request misses the mid-level cache(s)). If the read request misses in the LLC, the data is retrieved from system memory 434. In another case, the cache agent 412 may intercept a write request from an L1 cache. If the write request hits the L2 cache after a tag lookup, then the cache agent 412 may perform an in-place write of the data in the cache line. If there is a miss, the cache agent 412 may create a read request to the LLC to bring in the data to the L2 cache. If there is a miss in the LLC, the data is retrieved from system memory 434. Various examples contemplate any number of caches and any suitable caching implementations.

A cache agent 412 may be associated with one or more processing elements (e.g., cores 402) and may process memory requests from these processing elements. In various examples, a cache agent 412 may also manage coherency between all of its associated processing elements. For example, a cache agent 412 may initiate transactions into coherent memory and may retain copies of data in its own cache structure. A cache agent 412 may also provide copies of coherent memory contents to other cache agents.

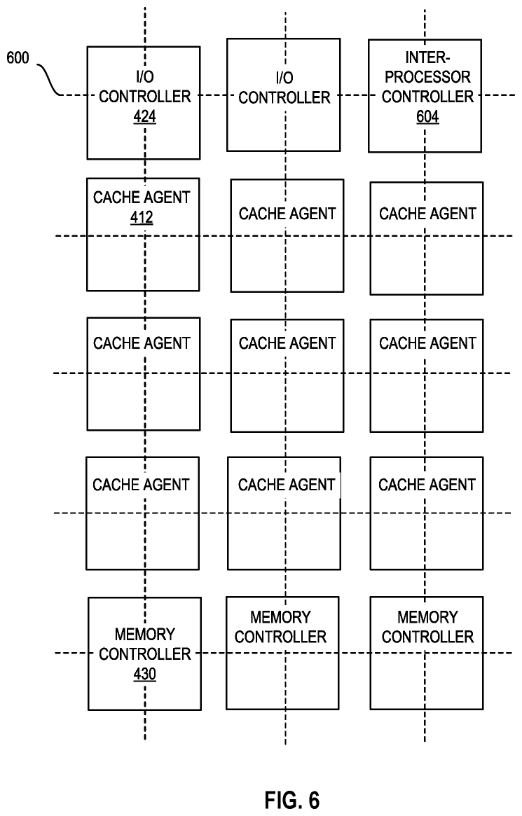

In various examples, a cache agent 412 may receive a memory request and route the request towards an entity that facilitates performance of the request. For example, if cache agent 412 of a processor receives a memory request specifying a memory address of a memory device (e.g., system memory 434) coupled to the processor, the cache agent 412 may route the request to a memory controller 430 that manages the particular memory device (e.g., in response to a determination that the data is not cached at processor 400. As another example, if the memory request specifies a memory address of a memory device that is on a different processor (but on the same computing node), the cache agent 412 may route the request to an inter-processor communication controller (e.g., controller 604 of FIG. 6) which communicates with the other processors of the node. As yet another example, if the memory request specifies a memory address of a memory device that is located on a different computing node, the cache agent 412 may route the request to a fabric controller (which communicates with other computing nodes via a network fabric such as an Ethernet fabric, an Intel Omni-Path Fabric, an Intel True Scale Fabric, an InfiniBand-based fabric (e.g., Infiniband Enhanced Data Rate fabric), a RapidIO fabric, or other suitable board-to-board or chassis-to-chassis interconnect).

In particular examples, the cache agent 412 may include a system address decoder that maps virtual memory addresses and/or physical memory addresses to entities associated with the memory addresses. For example, for a particular memory address (or region of addresses), the system address decoder may include an indication of the entity (e.g., memory device) that stores data at the particular address or an intermediate entity on the path to the entity that stores the data (e.g., a computing node, a processor, a memory controller, an inter-processor communication controller, a fabric controller, or other entity). When a cache agent 412 processes a memory request, it may consult the system address decoder to determine where to send the memory request.

In particular examples, a cache agent 412 may be a combined caching agent and home agent, referred to herein in as a caching home agent (CHA). A caching agent may include a cache pipeline and/or other logic that is associated with a corresponding portion of a cache memory, such as a distributed portion (e.g., 414) of a last level cache. Each individual cache agent 412 may interact with a corresponding LLC slice (e.g., cache 414). For example, cache agent 412A interacts with cache 414A, cache agent 412B interacts with cache 414B, and so on. A home agent may include a home agent pipeline and may be configured to protect a given portion of a memory such as a system memory 434 coupled to the processor. To enable communications with such memory, CHAs may be coupled to memory controller 430.

In general, a CHA may serve (via a caching agent) as the local coherence and cache controller and also serve (via a home agent) as a global coherence and memory controller interface. In an example, the CHAs may be part of a distributed design, wherein each of a plurality of distributed CHAs are each associated with one of the cores 402. Although in particular examples a cache agent 412 may comprise a cache controller and a home agent, in other examples, a cache agent 412 may comprise a cache controller but not a home agent.

Various examples of the present disclosure may provide variable cacheline set mapping (VCSM) technology for any suitable component of the processor 400 (e.g., a core 402, a cache agent 412, a memory controller 430, etc.) that allows the component to vary a mapping function used to lookup entries in memory/cache.

In some examples, one or more of the cores 402, the cache agents 412, and the memory controller 430 may be further configured to map an index to a particular set of one or more sets associated with their respective caches/memory (e.g., L1D, L1I, L2, cache 414, main memory 434, etc.) based on an indicated map function of two or more map functions, and lookup an entry in their respective caches/memory based at least in part on the particular set indicated by the mapped index. For example, the cores 402/agents 412/controller 430 may be configured to select the indicated map function based at least in part on an indication from a software agent (e.g., an operating system (OS), a virtual machine manager (VMM), etc.). For example, the indication from the software agent may be read from a register (e.g., a control register, a configuration register, a MSR, etc.).

The bandwidth provided by a coherent fabric interconnect 410 (which may provide an external interface to a storage medium to store the captured trace) may allow lossless monitoring of the events associated with the caching agents 412. In various examples, the events at each cache agent 412 of a plurality of cache agents of a processor may be tracked. Accordingly, the VCSM technology may successfully vary the cacheline set mapping at runtime without requiring the processor 400 to be globally deterministic.

I/O controller 424 may include logic for communicating data between processor 400 and I/O devices 426, which may refer to any suitable devices capable of transferring data to and/or receiving data from an electronic system, such as processor 400. For example, an I/O device may be a network fabric controller; an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input device such as a monitor, printer, mouse, keyboard, or scanner; or other suitable device.

An I/O device 426 may communicate with I/O controller 424 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In various examples, I/O devices 426 coupled to the I/O controller 424 may be located off-chip (i.e., not on the same integrated circuit or die as a processor) or may be integrated on the same integrated circuit or die as a processor.

Memory controller 430 is an integrated memory controller (i.e., it is integrated on the same die or integrated circuit as one or more cores 402 of the processor 400) that includes logic to control the flow of data going to and from system memory 434. Memory controller 430 may include logic operable to read from a system memory 434, write to a system memory 434, or to request other operations from a system memory 434. In various examples, memory controller 430 may receive write requests originating from cores 402 or I/O controller 424 and may provide data specified in these requests to a system memory 434 for storage therein. Memory controller 430 may also read data from system memory 434 and provide the read data to I/O controller 424 or a core 402. During operation, memory controller 430 may issue commands including one or more addresses (e.g., row and/or column addresses) of the system memory 434 in order to read data from or write data to memory (or to perform other operations). In some examples, memory controller 430 may be implemented in a different die or integrated circuit than that of cores 402.

Although not depicted, a computing system including processor 400 may use a battery, renewable energy converter (e.g., solar power or motion-based energy), and/or power supply outlet connector and associated system to receive power, a display to output data provided by processor 400, or a network interface allowing the processor 400 to communicate over a network. In various examples, the battery, power supply outlet connector, display, and/or network interface may be communicatively coupled to processor 400.

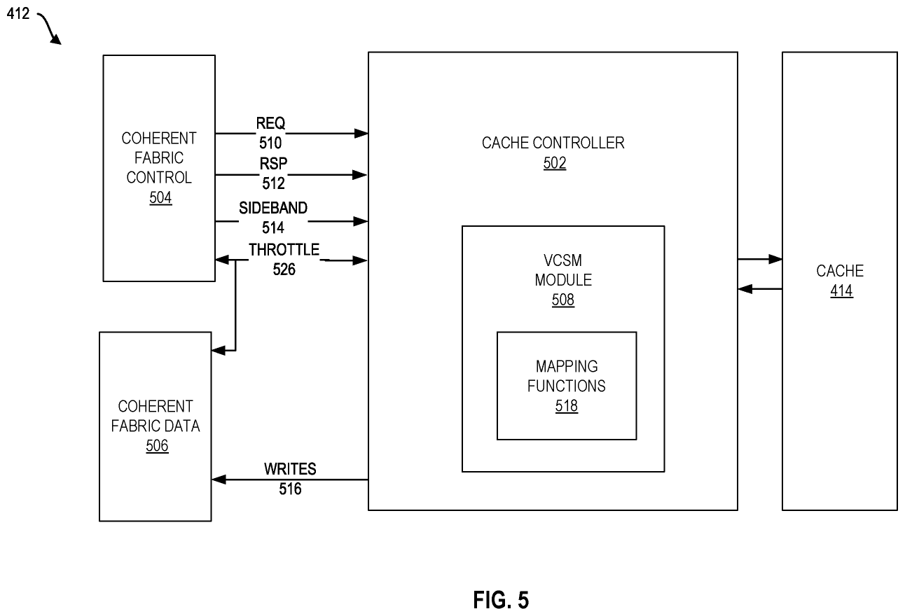

FIG. 5 is a block diagram of a cache agent 412 comprising a VCSM module 508 in accordance with certain examples. The VCSM module 508 may include one or more aspects of any of the examples described herein. The VCSM module 508 may be implemented using any suitable logic. In a particular example, the VCSM module 508 may be implemented through firmware executed by a processing element of cache agent 412. In this example, the VCSM module 508 applies a particular map function selected from multiple mapping functions 518 to map indexes to lookup entries in the cache 414.

In a particular example, a separate instance of a VCSM module 508 may be included within each cache agent 412 for each cache controller 502 of a processor 400. In another example, a VCSM module 508 may be coupled to multiple cache agents 412 and map indexes for each of the cache agents. The processor 400 may include a coherent fabric interconnect 410 (e.g., a ring or mesh interconnect) that connects the cache agents 412 to each other and to other agents which are able to support a relatively large amount of bandwidth (some of which is to be used to communicate traced information to a storage medium), such as at least one I/O controller (e.g., a PCIe controller) and at least one memory controller.

The coherent fabric control interface 504 (which may include any suitable number of interfaces) includes request interfaces 510, response interfaces 512, and sideband interfaces 514. Each of these interfaces is coupled to cache controller 502. The cache controller 502 may issue writes 516 to coherent fabric data 506.

A throttle signal 526 is sent from the cache controller 502 to flow control logic of the interconnect fabric 410 (and/or components coupled to the interconnect fabric 410) when bandwidth becomes constrained (e.g., when the amount of bandwidth available on the fabric is not enough to handle all of the writes 516). In a particular example, the throttle signal 526 may go to a mesh stop or ring stop which includes a flow control mechanism that allows acceptance or rejection of requests from other agents coupled to the interconnect fabric. In various examples, the throttle signal 526 may be the same throttle signal that is used to throttle normal traffic to the cache agent 412 when a receive buffer of the cache agent 412 is full. In a particular example, the sideband interfaces 514 (which may carry any suitable messages such as credits used for communication) are not throttled, but sufficient buffering is provided in the cache controller 502 to ensure that events received on the sideband interface(s) are not lost.

FIG. 6 is an example mesh network 600 comprising cache agents 412 in accordance with certain examples. The mesh network 600 is one example of an interconnect fabric 410 that may be used with various examples of the present disclosure. The mesh network 600 may be used to carry requests between the various components (e.g., I/O controllers 424, cache agents 412, memory controllers 430, and inter-processor controller 604).

Inter-processor communication controller 604 provides an interface for inter-processor communication. Inter-processor communication controller 604 may couple to an interconnect that provides a transportation path between two or more processors. In various examples, the interconnect may be a point-to-point processor interconnect, and the protocol used to communicate over the interconnect may have any suitable characteristics of Intel Ultra Path Interconnect (UPI), Intel QuickPath Interconnect (QPI), or other known or future inter-processor communication protocol. In various examples, inter-processor communication controller 604 may be a UPI agent, QPI agent, or similar agent capable of managing inter-processor communications.

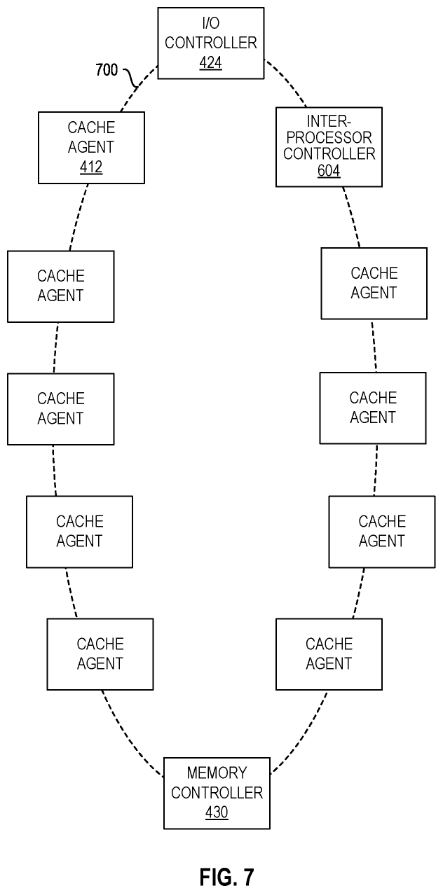

FIG. 7 is an example ring network comprising cache agents 412 in accordance with certain examples. The ring network 700 is one example of an interconnect fabric 410 that may be used with various examples of the present disclosure. The ring network 700 may be used to carry requests between the various components (e.g., I/O controllers 424, cache agents 412, memory controllers 430, and inter-processor controller 604).

FIG. 8 is a block diagram of another example of a cache agent 800 comprising VCSM technology in accordance with certain examples. In the example depicted, cache agent 800 is a CHA 800, which may be one of many distributed CHAs that collectively form a coherent combined caching home agent for processor 400 (e.g., as the cache agent 412). In general, the CHA includes various components that couple between interconnect interfaces. Specifically, a first interconnect stop 810 provides inputs from the interconnect fabric 410 to CHA 800 while a second interconnect stop 870 provides outputs from the CHA to interconnect fabric 410. In an example, a processor may include an interconnect fabric such as a mesh interconnect or a ring interconnect such that stops 810 and 870 are configured as mesh stops or ring stops to respectively receive incoming information and to output outgoing information.

As illustrated, first interconnect stop 810 is coupled to an ingress queue 820 that may include one or more entries to receive incoming requests and pass them along to appropriate portions of the CHA. In the implementation shown, ingress queue 820 is coupled to a portion of a cache memory hierarchy, specifically a snoop filter (SF) cache and a LLC (SF/LLC) 830 (which may be a particular example of cache 414). In general, a snoop filter cache of the SF/LLC 830 may be a distributed portion of a directory that includes a plurality of entries that store tag information used to determine whether incoming requests hit in a given portion of a cache. In an example, the snoop filter cache includes entries for a corresponding L2 cache memory to maintain state information associated with the cache lines of the L2 cache. However, the actual data stored in this L2 cache is not present in the snoop filter cache, as the snoop filter cache is rather configured to store the state information associated with the cache lines. In turn, LLC portion of the SF/LLC 830 may be a slice or other portion of a distributed last level cache and may include a plurality of entries to store tag information, cache coherency information, and data as a set of cache lines. In some examples, the snoop filter cache may be implemented at least in part via a set of entries of the LLC including tag information.

Cache controller 840 may include various logic to perform cache processing operations. In general, cache controller 840 may be configured as a pipelined logic (also referred to herein as a cache pipeline) that further includes VCSM technology implemented with variable mapping circuitry 818 for lookup requests. The cache controller 840 may perform various processing on memory requests, including various preparatory actions that proceed through a pipelined logic of the caching agent to determine appropriate cache coherency operations. SF/LLC 830 couples to cache controller 840. Response information may be communicated via this coupling based on whether a lookup request (received from ingress queue 820) hits (or not) in the snoop filter/LLC 830. In general, cache controller 840 is responsible for local coherency and interfacing with the SF/LLC 830, and may include one or more trackers each having a plurality of entries to store pending requests.

As further shown, cache controller 840 also couples to a home agent 850 which may include a pipelined logic (also referred to herein as a home agent pipeline) and other structures used to interface with and protect a corresponding portion of a system memory. In general, home agent 850 may include one or more trackers each having a plurality of entries to store pending requests and to enable these requests to be processed through a memory hierarchy. For read requests that miss the snoop filter/LLC 830, home agent 850 registers the request in a tracker, determines if snoops are to be spawned, and/or memory reads are to be issued based on a number of conditions. In an example, the cache memory pipeline is roughly 9 clock cycles, and the home agent pipeline is roughly 4 clock cycles. This allows the CHA 800 to produce a minimal memory/cache miss latency using an integrated home agent.

Outgoing requests from cache controller 840 and home agent 850 couple through a staging buffer 860 to interconnect stop 870. In an example, staging buffer 860 may include selection logic to select between requests from the two pipeline paths. In an example, cache controller 840 generally may issue remote requests/responses, while home agent 850 may issue memory read/writes and snoops/forwards.

With the arrangement shown in FIG. 8, first interconnect stop 810 may provide incoming snoop responses or memory responses (e.g., received from off-chip) to home agent 850. Via coupling between home agent 850 and ingress queue 820, home agent completions may be provided to the ingress queue. In addition, to provide for optimized handling of certain memory transactions as described herein (updates such as updates to snoop filter entries), home agent 850 may further be coupled to cache controller 840 via a bypass path, such that information for certain optimized flows can be provided to a point deep in the cache pipeline of cache controller 840. Note also that cache controller 840 may provide information regarding local misses directly to home agent 850. While a particular cache agent architecture is shown in FIG. 8, any suitable cache agent architectures are contemplated in various examples of the present disclosure.

The figures below detail exemplary architectures and systems to implement examples of the above. In some examples, one or more hardware components and/or instructions described above are emulated as detailed below, or implemented as software modules.

Processor cores may be implemented in different ways, for different purposes, and in different processors. For instance, implementations of such cores may include: 4) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 4) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 4) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a SoC that may include on the same die the described CPU (sometimes referred to as the application core(s) or application processor(s)), the above described coprocessor, and additional functionality. Exemplary core architectures are described next, followed by descriptions of exemplary processors and computer architectures.

FIG. 9 depicts a block diagram of a SoC 900 in accordance with an example of the present disclosure. Similar elements in FIG. 15 bear similar reference numerals. Also, dashed lined boxes are optional features on more advanced SoCs. In FIG. 9, an interconnect unit(s) 902 is coupled to: an application processor 1500 which includes a set of one or more cores 1502A-N with cache unit(s) 1504A-N and shared cache unit(s) 1506; a bus controller unit(s) 1516; an integrated memory controller unit(s) 1514; a set or one or more coprocessors 920 which may include integrated graphics logic, an image processor, an audio processor, and a video processor; an static random access memory (SRAM) unit 930; a direct memory access (DMA) unit 932; a display unit 940 for coupling to one or more external displays; and a system agent unit 910 that includes VCSM technology, as described herein, implemented with variable mapping circuitry 918 to lookup requests of various cache/memory of the SoC 900. In one example, the coprocessor(s) 920 include a special-purpose processor, such as, for example, a network or communication processor, compression and/or decompression engine, GPGPU, a high-throughput MIC processor, embedded processor, or the like.

With reference to FIG. 10, an example of a system 1000 includes various caches that may utilize examples of the VCSM technology described herein. In some examples, a last-level cache (LLC) may utilize VCSM technology. In some examples, as shown in FIG. 10, a level four (L4) cache may utilize VCSM technology. For example, the system 1000 includes multiple processor cores 1011A-D and an I/O interface 1013 (e.g., a compute express link (CXL) interface coupled to a hub 1015 (e.g., a platform controller hub (PCH)). The hub 1015 includes L4 cache and snoop filters (e.g., ULTRA PATH INTERCONNECT (UPI) snoop filters). One or more of the I/O interface 1013, the snoop filters, the cores 1011 (e.g., in connection with either an L1 or L2 cache), and the hub 1015 may be configured to utilize examples of the VCSM technology described herein. As illustrated, the hub 1015 is configured to implement variable mapping circuitry 1018.

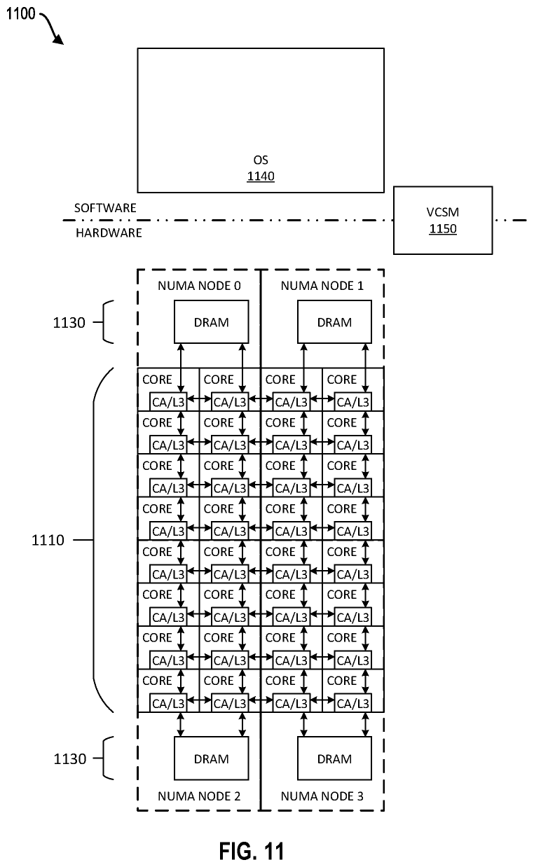

With reference to FIG. 11, an embodiment of a server 1100 includes a processor 1110 that supports SNC. As shown in FIG. 11, multiple cores each include a caching agent (CA) and L3 cache as a last-level cache (LLC) for system memory 1130 (e.g., DRAM) logically partitioned into four clusters (e.g., organized in SNC-4 mode with NUMA node 0 through NUMA node 3). The user can pin each software thread to a specific cluster, and if data is managed data appropriately, LLC and DRAM access latencies and/or on-die interconnect traffic may be reduced. The server 1100 includes an OS 1140 and VCSM technology 1150 (e.g., both hardware and software aspects) as described herein.

Some implementations provide technology for configurable cacheline set mapping to detect and avoid rare aliasing conditions. In a two-part cache accessing scheme utilized by a conventional processor, access to an addressed memory location through a cache proceeds by having in one part, a subset of the addressing bits (e.g., an index) map to a set of blocks with a fixed mapping function. The mapped-to set has a number of ways (e.g., 8 ways, 12 ways, 16 ways, etc.) among the set of blocks. The right way is selected through an associative match of a tag portion of the address in a second part (e.g., another subset of the addressing bits). The offset within that selected block, that is supplied by the low order bits in the address (e.g., not used in tag or index), is then supplied by the caching unit.

In outer caches (like L2, LLC), a physically indexed, physically tagged (PIPT) scheme may be used, where both the index and tag are from the physical address of the data. In an inner cache (like L1), a virtually indexed, physically tagged (VIPT) scheme may be employed to let the set-mapping selection proceed directly from the index portion in the virtual address (e.g., typically from bitfield 6-11), and then using the tag from the translated (physical) address for the associative match. Utilizing the index portion in the virtual address lets the translation look-aside buffer (TLB) lookup proceed in parallel with the index based set selection. A problem is that various memory access patterns may be less performant and/or may cause other issues with the cache utilization due to the fixed mapping function.

In one illustrative problem, an application may involve a matrix layout and/or matrix multiplication (e.g., matrix multiplication may be a representative use case of a highly regular pattern of accesses in processor caches). For some applications, depending for example on cacheline utilization for the various rows and columns of the matrix, the physical address of each row may map into different cachesets. Depending on the mapping and the access pattern, a rare aliasing condition may occur. Without being limited to theory of operation, some rare aliasing conditions may be caused by a high degree of conflicts in processor cache addresses. In some scenarios, the conflicts may be due to concurrent accesses landing over the same sets and thus causing recently used cachelines to be evicted (e.g., unlike other scenarios where cache misses arise primarily due to high dynamic footprint or due to false sharing conflicts). Another problem is that multiple spatially regular streams may have physical-addresses in memory that land the streams against the same sets of cachelines due to an underlying fixed map function (e.g., a map function that is not changeable by hardware or software). Software approaches to avoiding such conflicts may include padding the matrix and/or changing the stride. But a problem with such approaches is that software developers may not recognize the aliasing problem, padding and/or changing the stride impacts memory allocation and management, and the aliasing problem may still occur on different processors that have different fixed mapping functions (e.g., a software approach is not generalized because adding padding may or may not help the same algorithm or code on different CPUs or may help in one cache and not help in another cache).

Some implementations may address or overcome one or more of the foregoing problems. Some examples provide technology for variable mapping circuitry (hardware) that provides an option to alter the mapping function in a way that keeps the mapping function itself opaque, but malleable to guidance provided by software. In some implementations, a processor may utilize the variable mapping circuitry to map a physical address to an associative set. The processor/circuitry may also ignore input provided by differently privileged software under a configurable policy option, so that the guidance does not result in a need to validate more than a few variants of the mapping function.

With reference to FIG. 12A, an example of memory access circuitry 1200 implements an N-way associate set lookup for a memory (e.g., a cache). The memory access circuitry 1200 includes variable mapping circuitry 1204. Access to a memory location at an address 1202 proceeds by variably mapping an index field of the address 1202 to a set of blocks. The mapped-to set has N ways (e.g., 8 ways, 12 ways, 16 ways, etc.) among the set of blocks. The right way is selected through an associative match of a tag portion of the address 1202. The offset within that selected block, that is supplied by the low order bits in the address 1202 (e.g., not used in tag or index). Advantageously, the mapping function applied to the index may be varied by the variable mapping circuitry 1204 (e.g., to improve performance, to avoid rare aliasing conditions, etc.). In some examples, the Tag may be extended to include some information from Index bits. In some examples, the nominal mapping of Tag+Index+Offset=Address may work well because the Tag portion for a cacheline may accurately represent an address. In other examples, a variable mapping may be created where two indexes may map to same Set, and a Tag together with some Index information may be utilized to identify a unique address.

In some examples, a cache controller or other suitable hardware may utilize variable mapping technology as described herein to vary the mapping function, without any guidance from software (e.g., based on hardware monitoring, closed loop feedback, etc.). In other examples, the variable mapping technology may be configured to vary the mapping function based on guidance from software. For example, suitable software may invoke a trusted communication via privileged software (an OS, a VMM, etc.), and provide guidance on which portions of a physical address should contribute to the mapping for a PIPT cache and to what extent.

FIG. 12B shows an example of a computing system 1210 that includes software 1215, a VMM/Host OS 1220, and hardware 1225, coupled as shown. The hardware 1225 includes a cache 1230, memory 1240, a mapping setting 1260 (e.g., a storage location that stores a value that indicates a desired mapping function for the variable mapping), and variable mapping circuitry 1270, coupled as shown. The variable mapping circuitry 1270 is operable to select between several mapping functions, such as the illustrated mapping 0 (e.g., a default mapping function), mapping 1, and mapping 2.

Conventionally, software has no input/effect as to what bitfields are used and what bits in each bitfield are selected for mapping to a set, or how the bits are permuted (e.g., or more generally, how the mapping function would translate an access pattern at the address level into an access pattern at the set level). Advantageously, some examples provide multiple mapping functions and provide technology for software to provide runtime guidance as to which one of the multiple mapping functions to apply. From the point of view of the software 1215, the baseline mapping (e.g., mapping 0), or a first alternate mapping (e.g., mapping 1), or a second alternate mapping (e.g., mapping 2), may all be equally opaque. The software 1215 only needs to be able to break up a memory or set access pattern if the software 1215 detects or is informed of an excessive number of misses to the cache 1230 (e.g., while performing a rectangular, matrix, or 3D access pattern). As illustrated in FIG. 12B, if the software 1215 detects a condition where another mapping option may be beneficial, the software 1215 notifies the VMM/OS 1220. The VMM/OS 1220 then 1) flushes the cache 1230; and 2) switches to a different set mapping (e.g., by writing an appropriate value to the mapping setting 1260).

When effecting a mapping change, upon receiving guidance from the software 1215, the VMM/OS 1220 may wait some predetermined amount of time (e.g., a short time), then bring everything to a barrier (e.g., similar to how the VMM/OS 1220 may operate for a global TLB shootdown), then flush the cache 1230 into a next level cache or memory 1240 (e.g., flush L1 contents into L2, flush L2 contents to LLC, flush LLC into external memory, etc.), notify all processors/cores to cut over to the alternate mapping, and then resume. When memory accesses resume, the variable mapping circuitry 1270 applies the new mapping function as indicated by the mapping setting 1260. In some examples, the task of cache flush and set mapping switch may need to be bundled together and may be made non-interruptible to avoid other issues.

In some implementations, hardware may implement examples of variable mapping flexibility on a per sub-NUMA (non-uniform memory access) cluster (SNC) basis. In some examples, where software can provide a guarantee that there is no physical memory sharing across different virtual machines and where the virtual machines have their virtual CPUs affinitized to disjoint sets of physical CPUs (e.g., a vCPU1 in a virtual machine VM1 is affinitized to a set of physical CPUIs that does not overlap with another set of physical CPU2s affinitized to another vCPU2 in a different virtual machine VM2), then variable mapping changes may be applied independently at a virtual machine granularity.

A default mapping for an index in a PIPT cache may have some bits from a lower order field (bits 6-11), and zero or more bits from a higher order field. In some examples, an alternative mapping for an index in a PIPT cache may have some bits from a lower order field but also may wire in some cross-influence between lower order bitfields and higher order bitfields. Without being limited to theory of operation, suitable cross-influence may influence a rhythmic wrap-around that reinforces set-conflicts between two access streams to get staggered by changing a phase difference between the default and the alternative mappings. With the alternative mapping, for example, one stream may distribute memory accesses in a nominal set order of S0, S1, S2, . . . , S15, while another stream may distribute memory accesses in a different set order of S3, S4, . . . , S15, S0, S1, S2, while yet another stream may distribute memory accesses in a different set order S14, S15, S0, S1, S6, S7, S8, S9, S2, S3, S12, S13, S4, S5, S10, S11. By breaking up periodicities in the memory accesses, the streams randomize the selection of sets when software recognizes (e.g., by analysis of suitable performance metrics) that cache misses are too high, and the software then requests that the variable mapping hardware cut over to a variant mapping. Advantageously, some examples give software flexibility in dealing with undesirable effects (e.g., rhythmic effects) when the undesirable effects develop (e.g., at runtime) because some high order bits have the same harmonics given multiple different stride patterns that happen to wrap around destructively in processor caches.

In some examples, performance management and/or optimization middleware may monitor memory performance metrics to identify conditions where statistically measured mean residencies show either high variation across different cache sets, or high variation of hit ratios or latencies, normalized to what a software developer or performance analyst considers a reference amount of work in the same workload or similar workloads. When a monitored condition is identified, performance management middleware may convey fresh guidance on physical address (PA) bitfield selections so that unfavorable harmonics in PA-to-cache set mappings may be dampened out by mixing the influence of a low order PA-bit into a few higher order PA-bits. Such guidance need not become effective immediately. Instead, the guidance may take effect at coarse time intervals because it may be necessary to evict caches as of a previous mapping and then refill the caches under the new mapping. Advantageously, some examples may lower a cache miss rate by switching different cacheline set mapping options, thereby improving application performance with just a configuration change and no code change.

An example baseline, default hardware mapping function uses a few bits from each of different bitfields F1, F2, F3, F4, . . . etc., of an address, where F1=bitfield 6-11 (e.g., because least significant bits LSBs 0-5 are contiguous bytes in the same cacheline), F2=bitfield 12-16, F3=bitfield 17-21, etc. Some number of bits from each of these bitfields are used for the index. For example, three bits selected from F1, two bits selected from F2, two more bits selected from F3, etc., up to the size of the index field. The default mapping function may combine the selected index bits in order, may switch orders of various of the selected bits, or may apply some hash function or other permutation of the selected bits to map the index to the sets.

For an example PIPT cache (e.g., an L2 cache), software may provide the guidance through an OS to the variable mapping hardware. In one example, the guidance that software provides to hardware may indicate that the software wants to inject bits from field F1 into one of the higher order bitfields (e.g., F2 or F3). In one example, in response to the guidance, F2 or F3 may each be expanded by one bit, where that extra bit comes from F1. In another example, two low order bits from F1 and one of the bits from F2 or F3 may be XOR'ed together. Each of the multiple mapping functions may be configured to maintain a roughly equal dispersion of spatially sequential and spatially correlated accesses from any one stream across the full set-width of the PIPT cache. For an L2 cache (e.g., that is a PITP cache), F1, F2, F3 bits are all available at the same time for the mapping. For a particular implementation, the bitfield F1 may cross-influence the patterns drawn from F2 or F3 in any suitable manner. Some implementations may have two or more alternate mappings to select between, based on software guidance. In general, only a few alternate mappings may provide sufficient flexibility to avoid most rare aliasing conditions.

For a PIPT cache, in some examples, reverse cross-influence may also be applied. For reverse cross-influence, one or more of higher order bits from fields F2, F3, etc., may be XOR'ed into one or more of the lower order bits in F1. A reverse cross-influence mapping variant may break up a rhythmic pattern such that sequential accesses crossing over from one physical page into a different physical page distribute over sets in the cache with a staggering of one or two cachelines. Accordingly, two different access streams stagger (with very high probability) separately at two different crossings of high order PA bits (e.g., because high order PA bits of two different access streams are relatively independent with very high probability, even under page coloring assumptions).

For a VIPT cache, the mapping may need to be different from as described above for a PIPT cache because the index selection may be limited to translation invariant low order bits 6-11 (e.g., for a 4K page, with bits 0-5 taken up for offsetting into a 64B cacheline). In some implementations, however, variable mapping may be suitable for use with a VIPT cache, with suitable constraints enforced by the OS. Instead of implementing a fully associative page allocation policy in which any 4K page backs any 4K virtual pages, the OS may create/assign physical pages to virtual pages using a set-associative scheme so that a virtual page V is backed by a physical page P such that the virtual address V and the physical address P have a 1:1 correspondence between some number of bits in an upper range (e.g., F2, comprising bits 14,15 just as an example). Note that this constraint is not the same as page coloring. Rather, in selecting a physical page frame P to back a virtual frame V, the OS imposes the noted constraint. In some implementations, the constraint is not onerous if the system has tens of GB or more of physical memory, because the number of pages that can satisfy the candidacy constraint may be large, and only the allocation lists have to be organized according to F2 values.

FIG. 12C shows examples of different mapping options. In some examples, the cacheline set mapping change is performed in hardware, which is opaque to software. While the application of the mapping change itself may be opaque to software, software may observe a temporary, transient spike in cache miss rates (e.g., due to a cache flush and refilling of the cache). In the example illustrated in FIG. 12C, F1=bitfield 6-11, and F2=bitfield 12-16. For the cacheline set mapping option 0, a default set mapping function directly uses F1 (bitfield 6-11) as the cache set index. For the cacheline set mapping option 1, a variant set mapping function uses one bit (bitfield 11) from F1, and XORs each bit from F2 (bitfield 12-16) with each of the lower bits from F1 (bitfield 6-10) as the other 5 bits in the variant set mapping function. In an example operation, option 0 may encounter a rare aliasing condition when visiting a small tile (e.g., a 64×64 sub-block) inside a matrix with a column size of a multiple of 1024 bytes, because the lower bits in F1 are not changed and there are only four different values in F1. Option 1, however, may avoid the aliasing condition. In some examples, where the current operation utilizes option 0 and software identifies the rare aliasing condition, the software then notifies the OS to switch to option 1. The lookup hardware is then reconfigured to use option 1 for the cacheline set mapping. Thereafter, operation may continue without the aliasing condition.

Those skilled in the art will appreciate that any suitable circuitry may be configured to provide and select between the example option 0 and option 1 mapping functions. For example, a data selector or multiplexer may output the appropriate value of either option 0 or option 1 based on a signal, a bit in a privileged register, etc. Similarly, additional options for more mapping functions may include further combinatorial logic/circuitry to provide additional variants to map the index bits to the selected set, with a wider multiplexer and more mapping setting bits for the signal or register bits to indicate the selected option.

FIG. 12D shows an example of a computing system 1280 that include a VMM/host OS 1290, a mapping setting 1292, and variable mapping circuitry 1294, coupled as shown. The variable mapping circuitry 1294 applies one of four cacheline set mapping functions (namely, mapping 0 (e.g., a default cacheline set mapping function), mapping 1, mapping 2, and mapping 3) in accordance with the mapping setting 1292. As illustrated in FIG. 12D, dashed boxes indicate process flow for an optimizer that may run in a middleware layer on the host. In the illustrated example, any of the applications (App X, App Y, App Z) may over time be found to have an undesirable mapping-related condition (e.g., such as a rare aliasing condition). In that case, a cohort of the application reports the condition to the optimizer. The optimizer may additionally or alternatively periodically check for the undesirable mapping-related conditions. If the optimizer determines that some other mapping is appropriate to try, the optimizer notifies the VMM/OS 1290 to pick a different mapping. If one or more alternative mappings have been tried, but the optimizer determines there is no alternative mapping does not avoid a rare aliasing condition for some significant application, then the optimizer notifies the VMM/OS 1290 to reset to the default mapping.

In some examples, variable mapping may be applied at a host physical address (HPA) level across a full host. For example, the same indexing and mapping may be utilized for different applications and/or for different VMs. In some examples, the mapping function may not be chosen by a single application, but rather may be chosen by arbitration provided by an optimization middleware layer that reconciles mapping changes according to indications of rare aliasing conditions reported by an application's cohort. A change in the cacheline set mapping may only be made in a rare case (e.g., a rare aliasing condition) where one application is negatively affected by the currently applied mapping (e.g., which may be due to a problematic resonance between the affected application's current access pattern and the current mapping). In some examples, a different mapping chosen at runtime by an optimizer may fix the problem for the affected application without negatively impacting other applications co-tenant with the affected application on the same platform.

When determined to be appropriate by the optimizer, the OS is notified and performs a one-time flush when moving from a current mapping to one of a number of alternative mappings. Following the flush, the new mapping applies across the entire host. As shown in FIG. 12D, the system 1280 may be configured to return to the default mapping if a highly anomalous situation occurs where each mapping setting causes a rare aliasing condition for some different but important co-tenant. Alternatively, some examples may be configured to support more than one cacheline set mapping at a time, as described in further detail below.

In some examples, aspects of variable mapping technology may be implemented as one or more modules, each of which may be implemented in hardware, software, or some combination thereof. In one example, a computing system that implements variable mapping technology may include module that nominally divide different aspects into a hardware module, a software module, a platform analyzer module, a platform optimizer module, and an OS/VMM.

In one example, the hardware module provides the ability to expose a knob (e.g., a mapping setting) to the OS/VMM. The knob may have some number of values (e.g., 0 (default), 1, 2, and 3 (for a four-valued knob)). Pre-silicon simulation, functional simulation, or any suitable technique to analyze of L1/L2 cache accesses against a set of traces may be utilized to identify a suitable number of variant mappings to be implemented by the hardware module that show good distribution across indexes, and to pick one of the hardware implemented mapping functions as a default. In some examples, each of the knob settings may be documented with what bits are used to map the index to the sets.

A software module of a low-level library may implement performance data collection routines by using, for example, INTEL Performance Monitor Unit (PMU), perf, Processor Counter Monitor (PCM), sep, scripting, etc. The software module may be further programmed to send the data to a platform analyzer service that is a supervisory service on the machine. The analyzer service may detect whether or not the received data shows evidence of an undesirable mapping-related condition. For example, the analyzer service may analyze the data for a pattern of too quick an eviction of too many frequently touched cachelines, especially in L1 and L2, and particularly for those applications that have high numbers of stalls from L1 and/or L2 misses but otherwise have negligible other stalls. The analyzer service may notify an optimizer service from time to time.

The optimizer service may determine if there is enough evidence over time of a sustained presence of a problem (e.g., frequently re-touched frequently evicted lines), and whether an affected application is flagged as a priority application (e.g., or is the sole tenant). If there is enough evidence over time of a problem that may be fixed by changing the mapping (e.g., a rare aliasing condition) then the optimizer may inform the OS/VMM and requests the OS/VMM to select another knob option. The optimizer service may then inform the OS/VMM of such problems from time to time (e.g., how frequently may be a tunable parameter). The optimizer service may also keep track of a history of such requests sent to the OS/VMM to pick different knob options, and the optimizer may try other knobs in turn if the problem persists. The optimizer service may also use that history to determine to return to the default knob and stay there for a long time if all other knobs too have not cleared up the problem, or has given rise to another problem for some other application.

The OS/VMM, as described in this invention, act when so directed by the optimizer service. The OS/VMM may act by bringing the host to a barrier point (e.g., using an inter-processor interrupt (IPI)), flushing all caches on all cores and sockets, and then applying a new knob setting. For example, the new knob setting may be applied by writing a memory-mapped IO (MMIO) register to select the right next knob. Then, after receiving confirmation from the hardware that a new mapping is now effective across all CPUs, the OS/VMM may once again flush the local cache where the OS/VMM performed the knob-setting operation, and release all CPUs from the barrier.

### Examples With More Than One Cacheline Set Mapping at a Time

In rare scenarios, a mapping setting that benefits one application may be detrimental to another application. In even rarer scenarios, no mapping setting may be available that is suitable for the various deployed applications. Some implementations may provide further technology to apply more than one cacheline set mapping at a time. In some examples, more than one mapping scheme may be applied over disjoint HPA ranges (e.g., when there is no single mapping scheme that is found to be sufficiently performant for all co-tenant applications).

Some implementations may be more concerned with avoiding rare aliasing conditions and less concerned with optimized performance of each application. Also, for most applications, precisely what kind of cache mapping pattern the application code might encounter may not be well understood at compile time. In general, most implementations may not need or expect similarity of co-tenant applications.

The kinds of performance rare aliasing conditions that some implementations may seek to avoid may happen when there is a destructive periodicity in an application between multiple streams of access in that application. A skewed mapping that breaks this rhythmic pattern in one application, so long as it still retains equitability of distribution across HPAs across different indexes, may generally not be detrimental other applications. The probability that two different applications A and B co-tenant on the same host, where both of application A and B are cache bound in L1/L2, and where a mapping that is badly resonant for A happens to be the only mapping that is not bad for B is extremely low (e.g., possible but highly improbable).

Complications may arise for a situation where some application A is given a new cacheline set mapping M1, while the rest of the applications and other software and/or data components are given a default cacheline set mapping M0. One complication is the application A may switch in general from one set of cores to another set of cores, where M0 may have been previously operational. Another complication is that the application A may, from time to time share pages (libraries, data regions) with other software components.

Some implementations may accommodate two or more cacheline set mappings. Multiple concurrent mappings may be desirable, for example, if the numbers of cores in a single physical host machine numbers into many hundreds to thousands and, in such a manycore machine, many more software components may be co-tenant, thereby increasing the likelihood that any one cacheline set mapping may provoke a rare aliasing condition effect for some tenant workload. In some examples, the following constraints/rules may be applied: 1) The OS/VMM hard partitions the cores among applications so that applications using some mapping M′ among themselves as a group only get scheduled among a group of cores at which that mapping M′ is made effective; 2) If two applications A and B are not in the same affinity group (as in constraint #1), then A and B should not share memory; Conversely, if A and B do share memory, then group them together; and 3) Host OS/VMM pages which normally do get shared across different applications due to kernel calls and hypervisor entries should be placed in a separate set of pages, and the hardware must use the default cacheline set mapping for accesses to that set of pages.

The foregoing constraints/rules may also be otherwise reasonable for extreme core count machines for other reasons as well. For example, if in a very large core count machine anything can run anywhere, then each read-for-ownership (RFO) may have a potentially large delay to settle depending on how many cores contain copies of the same cacheline data. Such NUMA effects may be contained by sub-clustering application groups to smaller affinity sets. Further, dividing cache capacity may be desirable so that a host/VMM can maintain a critical small portion of their cachelines at least in L2. Otherwise host/VMM entries may end up with poor instructions/cycle ratios as the cachelines of the entries get evicted out of L2 and LLC due to the combined effect of applications' active cache footprints.

With the foregoing constraints/rules, then, the division of applications into groups can follow a clustering principle. Applications that do share code/data may be clustered together into single affinity groups. Applications that have high sensitivity to cacheline set mapping and exhibit rare aliasing conditions may be placed in their own separate groups.

### Examples of a Mean Residency Time Performance Counter

Some examples herein may make various decisions based on an amount of mean residency time. Other technology and application may likewise make beneficial use of accurate mean residency time information. Conventional performance monitors may track L1 cache miss rates and L2 cache miss rates. L1 cache miss rates and L2 cache miss rates are different from mean residency time because cache miss statistics average out over all data and therefore cannot determine whether some cachelines that were touched, aged out too quickly, and then (on a randomly sampled basis) found to be available in LLC. If the aggregate rate of access is so high that the mean time between references to the same cacheline is just too high (e.g., a classic case of cache thrashing due to capacity) then many of the cachelines lost from LLC may be expected to be seen by the time a code loop returns to touch the cachelines again. Some implementations may sample the re-touched cachelines to identify the touch/evict/touch sequence within small time windows for frequently touched cachelines, and report on the re-touch information.

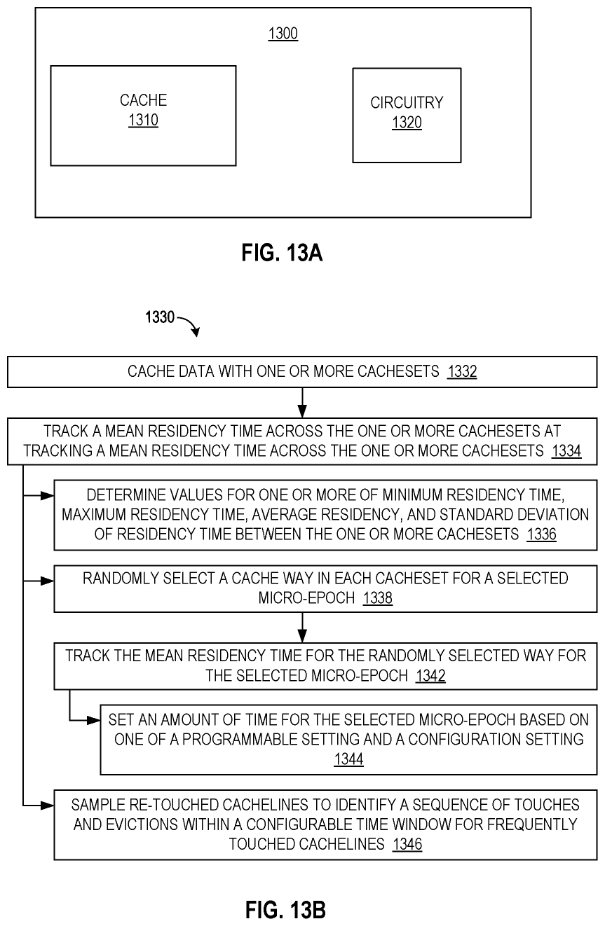

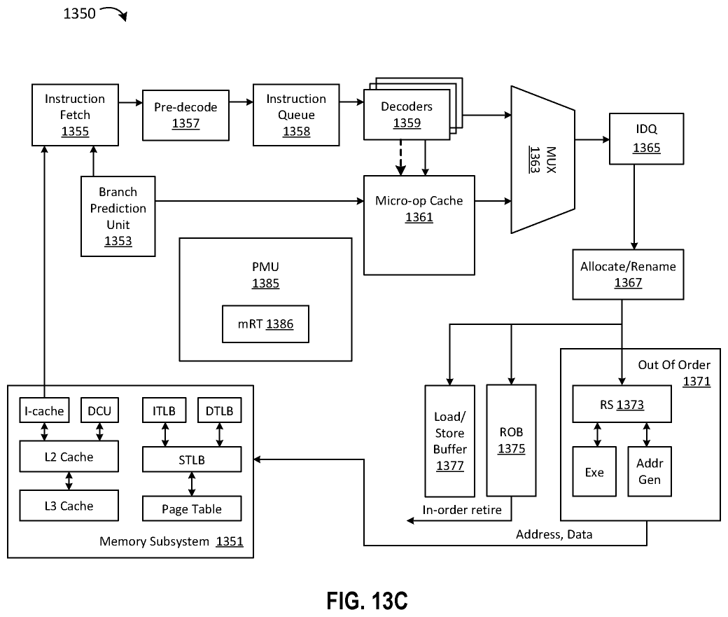

FIG. 13A shows an example of an integrated circuit 1300 comprising a cache 1310 with one or more cachesets and circuitry 1320 coupled to the cache 1310. The circuitry 1320 may be configured to track a mean residency time across the one or more cachesets. In some example, the circuitry 1320 may be further configured to determine values for one or more of minimum residency time, maximum residency time, average residency, and standard deviation of residency time between the one or more cachesets. For example, the circuitry 1320 may be configured to randomly select a cache way in each cacheset for a selected micro-epoch, and track the mean residency time for the randomly selected way for the selected micro-epoch. In some examples, the circuitry 1320 may also be configured to set an amount of time for the selected micro-epoch based on one of a programmable setting and a configuration setting, and/or to sample re-touched cachelines to identify a sequence of touches and evictions within a configurable time window for frequently touched cachelines.

For example, the circuitry 1320 may be incorporated in any of the processors/systems described herein. In some examples, the circuitry 1320 may be incorporated in the processor 400 (FIG. 4), the system 1210, the system 1280 (FIGS. 12A to 12D), processor 1400, the processor 1470, the processor 1415, the coprocessor 1438, the processor/coprocessor 1480 (FIG. 14), the processor 1500 (FIG. 15), the core 1690 (FIG. 16B), the execution units 1662 (FIGS. 16B and 17), and the processor 1916 (FIG. 19).

FIG. 13B shows an example of a method 1330 comprising caching data with one or more cachesets at 1332, and tracking a mean residency time across the one or more cachesets at 1334. Some examples of the method 1330 may further include determining values for one or more of minimum residency time, maximum residency time, average residency, and standard deviation of residency time between the one or more cachesets at 1336. For example, the method 1330 may include randomly selecting a cache way in each cacheset for a selected micro-epoch at 1338, and tracking the mean residency time for the randomly selected way for the selected micro-epoch at 1342. In some examples, the method 1330 may further include setting an amount of time for the selected micro-epoch based on one of a programmable setting and a configuration setting at 1344, and/or sampling re-touched cachelines to identify a sequence of touches and evictions within a configurable time window for frequently touched cachelines at 1346.

Some implementations may include counters that measure mRT (mean residency time) across different cachesets, and count values like min, max, average, and standard deviation values between the cachesets. For example, a high deviation value may indicate that the cachesets are not equally used during the selected micro-epoch. Together with other indicators such as when the average mRT is low and max mRT is high, some implementations may detect a condition where cachelines in some sets are frequently touched/evicted, where other sets do not exhibit the same behavior. The detected condition may indicate that there is an opportunity for more performant behavior with a different set mapping algorithm. Furthermore, such counters may help detect stream access, by checking that average mRT is low with small deviations, and may be beneficial from other perspectives (e.g., other than mapping-related) for performance monitoring and analysis of anomalies for L1/L2 cache sensitive workloads.

Performance monitoring hardware (e.g., such as INTEL Performance Monitoring Unit (PMU), Precise Event-Based Sampling (PEBS), Last Branch Recorded (LBR), etc.) may be beneficial for datacenter applications, especially to harvest at-scale performance online as opposed to offline pre-release performance profiling. Precise profiling in general may add value for various datacenter application frameworks by providing accurate information to a software context that may be experiencing performance issues. In some implementations, counters may be provided as part of performance monitor technology (e.g., an INTEL PMU) of a system/platform. In some examples, the PMU may make the counters available to suitable software to detect frequent eviction after low residency times. Examples may also be utilized by cloud vendors seeking efficient execution of workloads while optimizing system resources in a datacenter node. For example, embodiments may be utilized by INTEL technology referred to as Platform Monitoring Technology (PMY) for rack-scale design/out-of-band telemetry.

With reference to FIG. 13C, an embodiment of an out-of-order (OOO) processor core 1350 includes a memory subsystem 1351, a branch prediction unit (BPU) 1353, an instruction fetch circuit 1355, a pre-decode circuit 1357, an instruction queue 1358, decoders 1359, a micro-op cache 1361, a mux 1363, an instruction decode queue (IDQ) 1365, an allocate/rename circuit 1367, an out-of-order core 1371, a reservation station (RS) 1373, a re-order buffer (ROB) 1375, and a load/store buffer 1377, connected as shown. The memory subsystem 1351 includes a level-1 (L1) instruction cache (I-cache), a L1 data cache (DCU), a L2 cache, a L3 cache, an instruction translation lookaside buffer (ITLB), a data translation lookaside buffer (DTLB), a shared translation lookaside buffer (STLB), and a page table, connected as shown. The OOO core 1371 includes the RS 1373, an Exe circuit, and an address generation circuit, connected as shown. The core 1350 may further include or may be communicatively coupled to a PMU 1385 that includes one or more mRT related counters 1386, and other circuitry as described herein, to provide an accurate accounting of mRT.

In some examples, the PMU 1385 randomly selects a cache way in each set for any given micro-epoch. For example, a micro-epoch may last several milliseconds to several tens of milliseconds (e.g., either SW programmable, or fixed by a configuration knob to one of several intervals). At the randomly selected way, the PMU 1385 measures a mean residency time (mRT) in that set. For example, the PMU 1385 may implement Little's law. In another example, the PMU 1385 may randomly select and mark a cacheline that has entered the set in that way, and then collect the time when such randomly selected cachelines get displaced. Those skilled in the art will appreciate that any suitable technique may be utilized for alternative ways of collecting such mean residency times. If Little's law is implemented, then mRT may be calculated by using the duration of the micro-epoch divided by the frequency of evictions in that set.

In some implementations, the OS may program the PMU for a mRT event and a software module in the OS (e.g., or a daemon) then keeps track of the difference between min and max mRTs across the sets. The OS may report the means and standard deviations of mRTs across different sets, and across different cores, to applications when requested through a utility (such as Emon, Perf, etc.). As noted above, reporting of mRT is different from reporting just the raw counts of L1 hits and misses, L2 hits and misses, etc. Embodiments of the performance monitor hardware includes technology to provide fine grained metrics for spatial deviations across sets.

An application that experiences a high number of L1 or L2 misses may check whether the divergence of residency times as reported by the OS is very high. Higher than expected swings in the residency durations may indicate (not prove) time correlated conflicts in some sets and not in others, which cause the cache to be non-uniformly used from a spatial perspective. Advantageously, examples of mRT related metrics may provide a diagnostic aid that may be used in conjunction with other metrics (e.g., such as latency metrics) to observe whether a mapping function creates markedly different distributions of residency times across sets.

### Exemplary Computer Architectures

Detailed below are describes of exemplary computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 14 illustrates an exemplary system. Multiprocessor system 1400 is a point-to-point interconnect system and includes a plurality of processors including a first processor 1470 and a second processor 1480 coupled via a point-to-point interconnect 1450. In some examples, the first processor 1470 and the second processor 1480 are homogeneous. In some examples, first processor 1470 and the second processor 1480 are heterogenous. Though the exemplary system 1400 is shown to have two processors, the system may have three or more processors, or may be a single processor system.

Processors 1470 and 1480 are shown including integrated memory controller (IMC) circuitry 1472 and 1482, respectively. Processor 1470 also includes as part of its interconnect controller point-to-point (P-P) interfaces 1476 and 1478; similarly, second processor 1480 includes P-P interfaces 1486 and 1488. Processors 1470, 1480 may exchange information via the point-to-point (P-P) interconnect 1450 using P-P interface circuits 1478, 1488. IMCs 1472 and 1482 couple the processors 1470, 1480 to respective memories, namely a memory 1432 and a memory 1434, which may be portions of main memory locally attached to the respective processors.

Processors 1470, 1480 may each exchange information with a chipset 1490 via individual P-P interconnects 1452, 1454 using point to point interface circuits 1476, 1494, 1486, 1498. Chipset 1490 may optionally exchange information with a coprocessor 1438 via an interface 1492. In some examples, the coprocessor 1438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1470, 1480 or outside of both processors, yet connected with the processors via P-P interconnect, such that either or both processors' local cache information may be stored in the shared cache if a processor is placed into a low power mode.

Chipset 1490 may be coupled to a first interconnect 1416 via an interface 1496. In some examples, first interconnect 1416 may be a Peripheral Component Interconnect (PCI) interconnect, or an interconnect such as a PCI Express interconnect or another I/O interconnect. In some examples, one of the interconnects couples to a power control unit (PCU) 1417, which may include circuitry, software, and/or firmware to perform power management operations with regard to the processors 1470, 1480 and/or co-processor 1438. PCU 1417 provides control information to a voltage regulator (not shown) to cause the voltage regulator to generate the appropriate regulated voltage. PCU 1417 also provides control information to control the operating voltage generated. In various examples, PCU 1417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1417 is illustrated as being present as logic separate from the processor 1470 and/or processor 1480. In other cases, PCU 1417 may execute on a given one or more of cores (not shown) of processor 1470 or 1480. In some cases, PCU 1417 may be implemented as a microcontroller (dedicated or general-purpose) or other control logic configured to execute its own dedicated power management code, sometimes referred to as P-code. In yet other examples, power management operations to be performed by PCU 1417 may be implemented externally to a processor, such as by way of a separate power management integrated circuit (PMIC) or another component external to the processor. In yet other examples, power management operations to be performed by PCU 1417 may be implemented within BIOS or other system software.

Various I/O devices 1414 may be coupled to first interconnect 1416, along with a bus bridge 1418 which couples first interconnect 1416 to a second interconnect 1420. In some examples, one or more additional processor(s) 1415, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 1416. In some examples, second interconnect 1420 may be a low pin count (LPC) interconnect. Various devices may be coupled to second interconnect 1420 including, for example, a keyboard and/or mouse 1422, communication devices 1427 and a storage circuitry 1428. Storage circuitry 1428 may be one or more non-transitory machine-readable storage media as described below, such as a disk drive or other mass storage device which may include instructions/code and data 1430 in some examples. Further, an audio I/O 1424 may be coupled to second interconnect 1420. Note that other architectures than the point-to-point architecture described above are possible. For example, instead of the point-to-point architecture, a system such as multiprocessor system 1400 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a SoC that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 15 illustrates a block diagram of an example processor 1500 that may have more than one core and an integrated memory controller. The solid lined boxes illustrate a processor 1500 with a single core 1502A, a system agent unit circuitry 1510, a set of one or more interconnect controller unit(s) circuitry 1516, while the optional addition of the dashed lined boxes illustrates an alternative processor 1500 with multiple cores 1502(A)-(N), a set of one or more integrated memory controller unit(s) circuitry 1514 in the system agent unit circuitry 1510, and special purpose logic 1508, as well as a set of one or more interconnect controller units circuitry 1516. Note that the processor 1500 may be one of the processors 1470 or 1480, or co-processor 1438 or 1415 of FIG. 14.

Thus, different implementations of the processor 1500 may include: 1) a CPU with the special purpose logic 1508 being integrated graphics and/or scientific (throughput) logic (which may include one or more cores, not shown), and the cores 1502(A)-(N) being one or more general purpose cores (e.g., general purpose in-order cores, general purpose out-of-order cores, or a combination of the two); 2) a coprocessor with the cores 1502(A)-(N) being a large number of special purpose cores intended primarily for graphics and/or scientific (throughput); and 3) a coprocessor with the cores 1502(A)-(N) being a large number of general purpose in-order cores. Thus, the processor 1500 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1504(A)-(N) within the cores 1502(A)-(N), a set of one or more shared cache unit(s) circuitry 1506, and external memory (not shown) coupled to the set of integrated memory controller unit(s) circuitry 1514. The set of one or more shared cache unit(s) circuitry 1506 may include one or more mid-level caches, such as level 2 (L2), level 3 (L3), level 4 (L4), or other levels of cache, such as a last level cache (LLC), and/or combinations thereof. While in some examples ring-based interconnect network circuitry 1512 interconnects the special purpose logic 1508 (e.g., integrated graphics logic), the set of shared cache unit(s) circuitry 1506, and the system agent unit circuitry 1510, alternative examples use any number of well-known techniques for interconnecting such units. In some examples, coherency is maintained between one or more of the shared cache unit(s) circuitry 1506 and cores 1502(A)-(N).

In some examples, one or more of the cores 1502(A)-(N) are capable of multi-threading. The system agent unit circuitry 1510 includes those components coordinating and operating cores 1502(A)-(N). The system agent unit circuitry 1510 may include, for example, power control unit (PCU) circuitry and/or display unit circuitry (not shown). The PCU may be or may include logic and components needed for regulating the power state of the cores 1502(A)-(N) and/or the special purpose logic 1508 (e.g., integrated graphics logic). The display unit circuitry is for driving one or more externally connected displays.

The cores 1502(A)-(N) may be homogenous in terms of instruction set architecture (ISA). Alternatively, the cores 1502(A)-(N) may be heterogeneous in terms of ISA; that is, a subset of the cores 1502(A)-(N) may be capable of executing an ISA, while other cores may be capable of executing only a subset of that ISA or another ISA.

### Exemplary Core Architectures-in-Order and Out-of-Order Core Block Diagram

FIG. 16A is a block diagram illustrating both an exemplary in-order pipeline and an exemplary register renaming, out-of-order issue/execution pipeline according to examples. FIG. 16B is a block diagram illustrating both an exemplary example of an in-order architecture core and an exemplary register renaming, out-of-order issue/execution architecture core to be included in a processor according to examples. The solid lined boxes in FIGS. 16A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 16A, a processor pipeline 1600 includes a fetch stage 1602, an optional length decoding stage 1604, a decode stage 1606, an optional allocation (Alloc) stage 1608, an optional renaming stage 1610, a schedule (also known as a dispatch or issue) stage 1612, an optional register read/memory read stage 1614, an execute stage 1616, a write back/memory write stage 1618, an optional exception handling stage 1622, and an optional commit stage 1624. One or more operations can be performed in each of these processor pipeline stages. For example, during the fetch stage 1602, one or more instructions are fetched from instruction memory, and during the decode stage 1606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1606 and the register read/memory read stage 1614 may be combined into one pipeline stage. In one example, during the execute stage 1616, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 16B may implement the pipeline 1600 as follows: 1) the instruction fetch circuitry 1638 performs the fetch and length decoding stages 1602 and 1604; 2) the decode circuitry 1640 performs the decode stage 1606; 3) the rename/allocator unit circuitry 1652 performs the allocation stage 1608 and renaming stage 1610; 4) the scheduler(s) circuitry 1656 performs the schedule stage 1612; 5) the physical register file(s) circuitry 1658 and the memory unit circuitry 1670 perform the register read/memory read stage 1614; the execution cluster(s) 1660 perform the execute stage 1616; 6) the memory unit circuitry 1670 and the physical register file(s) circuitry 1658 perform the write back/memory write stage 1618; 7) various circuitry may be involved in the exception handling stage 1622; and 8) the retirement unit circuitry 1654 and the physical register file(s) circuitry 1658 perform the commit stage 1624.

FIG. 16B shows a processor core 1690 including front-end unit circuitry 1630 coupled to an execution engine unit circuitry 1650, and both are coupled to a memory unit circuitry 1670. The core 1690 may be a reduced instruction set architecture computing (RISC) core, a complex instruction set architecture computing (CISC) core, a very long instruction word (VLIW) core, or a hybrid or alternative core type. As yet another option, the core 1690 may be a special-purpose core, such as, for example, a network or communication core, compression engine, coprocessor core, general purpose computing graphics processing unit (GPGPU) core, graphics core, or the like.

The front end unit circuitry 1630 may include branch prediction circuitry 1632 coupled to an instruction cache circuitry 1634, which is coupled to an instruction translation lookaside buffer (TLB) 1636, which is coupled to instruction fetch circuitry 1638, which is coupled to decode circuitry 1640. In one example, the instruction cache circuitry 1634 is included in the memory unit circuitry 1670 rather than the front-end circuitry 1630. The decode circuitry 1640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1640 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1640 may be implemented using various different mechanisms. Examples of suitable mechanisms include, but are not limited to, look-up tables, hardware implementations, programmable logic arrays (PLAs), microcode read only memories (ROMs), etc. In one example, the core 1690 includes a microcode ROM (not shown) or other medium that stores microcode for certain macroinstructions (e.g., in decode circuitry 1640 or otherwise within the front end circuitry 1630). In one example, the decode circuitry 1640 includes a micro-operation (micro-op) or operation cache (not shown) to hold/cache decoded operations, micro-tags, or micro-operations generated during the decode or other stages of the processor pipeline 1600. The decode circuitry 1640 may be coupled to rename/allocator unit circuitry 1652 in the execution engine circuitry 1650.

The execution engine circuitry 1650 includes the rename/allocator unit circuitry 1652 coupled to a retirement unit circuitry 1654 and a set of one or more scheduler(s) circuitry 1656. The scheduler(s) circuitry 1656 represents any number of different schedulers, including reservations stations, central instruction window, etc. In some examples, the scheduler(s) circuitry 1656 can include arithmetic logic unit (ALU) scheduler/scheduling circuitry, ALU queues, arithmetic generation unit (AGU) scheduler/scheduling circuitry, AGU queues, etc. The scheduler(s) circuitry 1656 is coupled to the physical register file(s) circuitry 1658. Each of the physical register file(s) circuitry 1658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1658 includes vector registers unit circuitry, writemask registers unit circuitry, and scalar register unit circuitry. These register units may provide architectural vector registers, vector mask registers, general-purpose registers, etc. The physical register file(s) circuitry 1658 is coupled to the retirement unit circuitry 1654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1654 and the physical register file(s) circuitry 1658 are coupled to the execution cluster(s) 1660. The execution cluster(s) 1660 includes a set of one or more execution unit(s) circuitry 1662 and a set of one or more memory access circuitry 1664. The execution unit(s) circuitry 1662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1656, physical register file(s) circuitry 1658, and execution cluster(s) 1660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster-and in the case of a separate memory access pipeline, certain examples are implemented in which only the execution cluster of this pipeline has the memory access unit(s) circuitry 1664). It should also be understood that where separate pipelines are used, one or more of these pipelines may be out-of-order issue/execution and the rest in-order.

In some examples, the execution engine unit circuitry 1650 may perform load store unit (LSU) address/data pipelining to an Advanced Microcontroller Bus (AMB) interface (not shown), and address phase and writeback, data phase load, store, and branches.

The set of memory access circuitry 1664 is coupled to the memory unit circuitry 1670, which includes data TLB circuitry 1672 coupled to a data cache circuitry 1674 coupled to a level 2 (L2) cache circuitry 1676. In one exemplary example, the memory access circuitry 1664 may include a load unit circuitry, a store address unit circuit, and a store data unit circuitry, each of which is coupled to the data TLB circuitry 1672 in the memory unit circuitry 1670. The instruction cache circuitry 1634 is further coupled to the level 2 (L2) cache circuitry 1676 in the memory unit circuitry 1670. In one example, the instruction cache 1634 and the data cache 1674 are combined into a single instruction and data cache (not shown) in L2 cache circuitry 1676, a level 3 (L3) cache circuitry (not shown), and/or main memory. The L2 cache circuitry 1676 is coupled to one or more other levels of cache and eventually to a main memory.

The core 1690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1690 includes logic to support a packed data instruction set architecture extension (e.g., AVX1, AVX2), thereby allowing the operations used by many multimedia applications to be performed using packed data.

### Exemplary Execution Unit(s) Circuitry

FIG. 17 illustrates examples of execution unit(s) circuitry, such as execution unit(s) circuitry 1662 of FIG. 16B. As illustrated, execution unit(s) circuity 1662 may include one or more ALU circuits 1701, optional vector/single instruction multiple data (SIMD) circuits 1703, load/store circuits 1705, branch/jump circuits 1707, and/or Floating-point unit (FPU) circuits 1709. ALU circuits 1701 perform integer arithmetic and/or Boolean operations. Vector/SIMD circuits 1703 perform vector/SIMD operations on packed data (such as SIMD/vector registers). Load/store circuits 1705 execute load and store instructions to load data from memory into registers or store from registers to memory. Load/store circuits 1705 may also generate addresses. Branch/jump circuits 1707 cause a branch or jump to a memory address depending on the instruction. FPU circuits 1709 perform floating-point arithmetic. The width of the execution unit(s) circuitry 1662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

FIG. 18 is a block diagram of a register architecture 1800 according to some examples. As illustrated, the register architecture 1800 includes vector/SIMD registers 1810 that vary from 128-bit to 1,024 bits width. In some examples, the vector/SIMD registers 1810 are physically 512-bits and, depending upon the mapping, only some of the lower bits are used. For example, in some examples, the vector/SIMD registers 1810 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1800 includes writemask/predicate registers 1815. For example, in some examples, there are 8 writemask/predicate registers (sometimes called k0 through k7) that are each 16-bit, 32-bit, 64-bit, or 128-bit in size. Writemask/predicate registers 1815 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1815 corresponds to a data element position of the destination. In other examples, the writemask/predicate registers 1815 are scalable and consists of a set number of enable bits for a given vector element (e.g., 8 enable bits per 64-bit vector element).

The register architecture 1800 includes a plurality of general-purpose registers 1825. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1800 includes scalar floating-point (FP) register 1845 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1840 (e.g., EFLAGS, RFLAGS, etc.) store status and control information for arithmetic, compare, and system operations. For example, the one or more flag registers 1840 may store condition code information such as carry, parity, auxiliary carry, zero, sign, and overflow. In some examples, the one or more flag registers 1840 are called program status and control registers.

Segment registers 1820 contain segment points for use in accessing memory. In some examples, these registers are referenced by the names CS, DS, SS, ES, FS, and GS.

Machine specific registers (MSRs) 1835 control and report on processor performance. Most MSRs 1835 handle system-related functions and are not accessible to an application program. Machine check registers 1860 consist of control, status, and error reporting MSRs that are used to detect and report on hardware errors.

One or more instruction pointer register(s) 1830 store an instruction pointer value. Control register(s) 1855 (e.g., CR0-CR4) determine the operating mode of a processor (e.g., processor 1470, 1480, 1438, 1415, and/or 1500) and the characteristics of a currently executing task. Debug registers 1850 control and allow for the monitoring of a processor or core's debugging operations.

Memory (mem) management registers 1865 specify the locations of data structures used in protected mode memory management. These registers may include a GDTR, IDRT, task register, and a LDTR register.

In some examples, one or more map setting registers 1870 specify one or more map settings for variable mapping circuitry. For example, a n-bit map setting register may select between 2\hat{ } n map functions.

Alternative examples may use wider or narrower registers. Additionally, alternative examples may use more, less, or different register files and registers. The register architecture 1800 may, for example, be used in a register file/memory, or physical register file(s) circuitry 1658.

### Emulation (Including Binary Translation, Code Morphing, Etc.)

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 19 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 19 shows a program in a high-level language 1902 may be compiled using a first ISA compiler 1904 to generate first ISA binary code 1906 that may be natively executed by a processor with at least one first instruction set architecture core 1916. The processor with at least one first ISA instruction set architecture core 1916 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 1904 represents a compiler that is operable to generate first ISA binary code 1906 (e.g., object code) that can, with or without additional linkage processing, be executed on the processor with at least one first ISA instruction set architecture core 1916. Similarly, FIG. 19 shows the program in the high-level language 1902 may be compiled using an alternative instruction set architecture compiler 1908 to generate alternative instruction set architecture binary code 1910 that may be natively executed by a processor without a first ISA instruction set architecture core 1914. The instruction converter 1912 is used to convert the first ISA binary code 1906 into code that may be natively executed by the processor without a first ISA instruction set architecture core 1914. This converted code is not necessarily to be the same as the alternative instruction set architecture binary code 1910; however, the converted code will accomplish the general operation and be made up of instructions from the alternative instruction set architecture. Thus, the instruction converter 1912 represents software, firmware, hardware, or a combination thereof that, through emulation, simulation or any other process, allows a processor or other electronic device that does not have a first ISA instruction set architecture processor or core to execute the first ISA binary code 1906.

Techniques and architectures for variable cacheline set mapping technology are described herein. In the above description, for purposes of explanation, numerous specific details are set forth in order to provide a thorough understanding of certain examples. It will be apparent, however, to one skilled in the art that certain examples can be practiced without these specific details. In other instances, structures and devices are shown in block diagram form in order to avoid obscuring the description

### Additional Notes and Examples

Example 1 includes an apparatus comprising a memory, and circuitry coupled to the memory to map an index to a particular set of one or more sets based on an indicated map function of two or more map functions, and lookup an entry in the memory based at least in part on the particular set indicated by the mapped index.

Example 2 includes the apparatus of Example 1, wherein the circuitry is further to select the indicated map function based at least in part on an indication from a software agent.

Example 3 includes the apparatus of Example 2, wherein the circuitry is further to determine the indication from the software agent based on a value of a register.

Example 4 includes the apparatus of any of Examples 1 to 3, wherein a first map function of the two or more map functions is to promote a different access pattern for the memory as compared to a second map function of the two or more map functions.

Example 5 includes the apparatus of Example 4, wherein the second map function is to promote cross-influence of bits of the index relative to the first map function.

Example 6 includes the apparatus of any of Examples 4 to 5, wherein the circuitry is further to map the index to the particular set based on the second map function to inject one or more bits from a lower order bitfield of an address of an access request for the memory into a higher order bitfield of the address.

Example 7 includes the apparatus of Example 4, wherein the second map function is to promote reverse cross-influence of bits of the index relative to the first map function.

Example 8 includes the apparatus of any of Examples 4 and 7, wherein the circuitry is further to map the index to the particular set based on the second map function to inject one or more bits from a higher order bitfield of an address of an access request for the memory into a lower order bitfield of the address.

Example 9 includes an apparatus comprising a processor, a cache memory coupled to the processor, and circuitry coupled to the cache memory to apply a map function to map an address to an associative set of the cache memory, and alter the applied map function at runtime based at least in part on an indication from a software agent.

Example 10 includes the apparatus of Example 9, wherein the circuitry is further to alter the applied map function at runtime to vary a portion of the address that contributes to the map of the address to the associative set of the cache memory in accordance with the indication from the software agent.

Example 11 includes the apparatus of any of Examples 9 to 10, wherein the circuitry is further to alter the applied map function at runtime to vary an extent that the address contributes to the map of the address to the associative set of the cache memory in accordance with the indication from the software agent.

Example 12 includes the apparatus of any of Examples 9 to 11, wherein the circuitry is further to alter the applied map function at runtime to promote a different access pattern for the cache memory as compared to an immediately previously applied map function.

Example 13 includes the apparatus of any of Examples 9 to 12, wherein the circuitry is further to alter the applied map function at runtime to vary a periodicity of an access pattern for the cache memory as compared to an immediately previously applied map function.

Example 14 includes the apparatus of any of Examples 9 to 13, wherein the circuitry is further to alter the applied map function at runtime to change a cross-influence between low order bitfields and higher order bitfields of the address as compared to an immediately previously applied map function.

Example 15 includes the apparatus of any of Examples 9 to 14, wherein the circuitry is further to determine whether the applied map function is to be altered in accordance with the indication from the software agent based on one or more of a privilege level of the software agent and stored configuration information.

Example 16 includes the apparatus of any of Examples 9 to 15, wherein the circuitry is further to determine the indication from the software agent based on a value of a register.

Example 17 includes a method comprising exposing a setting to a software agent to indicate a request for a change in a mapping function for an associative set of a memory, and changing a hardware mapping function for looking up an entry in the associative set of the memory based on the exposed setting.

Example 18 includes the method of Example 17, further comprising selecting one of two or more mapping functions for the hardware mapping function based on the exposed setting.

Example 19 includes the method of Example 18, further comprising selecting bits of an index for the hardware mapping function based on the selected one of the two or more mapping functions.

Example 20 includes the method of any of Examples 17 to 19, further comprising collecting data to determine performance related information for the memory.

Example 21 includes the method of Example 20, further comprising analyzing the collected data, and determining whether to change the hardware mapping function based on the analysis.

Example 22 includes the method of Example 21, further comprising determining to change the hardware mapping function if the collected data shows a pattern of eviction rates above a first rate threshold and a pattern of a cacheline touch frequency above a second frequency threshold.

Example 23 includes the method of any of Examples 21 to 22, further comprising determining to change the hardware mapping function if the collected data shows statistically measured mean residencies that indicate a variation of mean residency across different associative sets of the memory in excess of a variation threshold.

Example 24 includes the method of any of Examples 21 to 23, further comprising determining to change the hardware mapping function if the collected data shows statistically measured mean residencies that indicate a variation in excess of a variation threshold for cache hit ratios normalized to a reference amount for a workload.

Example 25 includes the method of any of Examples 21 to 24, further comprising determining to change the hardware mapping function if the collected data shows statistically measured mean residencies that indicate a variation in excess of a variation threshold for access latency normalized to a reference amount for a workload.

Example 26 includes the method of any of Examples 21 to 25, wherein the memory comprises one or more of a level one (L1) cache and a level two (L2), further comprising determining to change the hardware mapping function if the collected data shows that an application is cache bound in one of the L1 cache and the L2 cache.

Example 27 includes the method of any of Examples 21 to 26, further comprising notifying the software agent to change the hardware mapping function, if so determined.

Example 28 includes the method of Example 27, further comprising, by the software agent in response to the notification bringing a host to a barrier point, flushing the memory, and providing the indication to request for the change in the mapping function for the associative set of the memory.

Example 29 includes an integrated circuit, comprising a cache with one or more cachesets, and circuitry coupled to the cache, the circuitry to track a mean residency time across the one or more cachesets.

Example 30 includes the integrated circuit of Example 29, wherein the circuitry is further to determine values for one or more of minimum residency time, maximum residency time, average residency, and standard deviation of residency time between the one or more cachesets.

Example 31 includes the integrated circuit of any of Examples 29 to 30, wherein the circuitry is further to randomly select a cache way in each cacheset for a selected micro-epoch.

Example 32 includes the integrated circuit of Example 31, wherein the circuitry is further to track the mean residency time for the randomly selected way for the selected micro-epoch.

Example 33 includes the integrated circuit of Example 32, wherein the circuitry is further to set an amount of time for the selected micro-epoch based on one of a programmable setting and a configuration setting.

Example 34. The integrated circuit of any of Examples 29 to 33, wherein the circuitry is further to sample re-touched cachelines to identify a sequence of touches and evictions within a configurable time window for frequently touched cachelines.

Example 35 includes a method comprising mapping an index to a particular set of one or more sets based on an indicated map function of two or more map functions, and looking up an entry in a memory based at least in part on the particular set indicated by the mapped index.

Example 36 includes the method of Example 35, further comprising selecting the indicated map function based at least in part on an indication from a software agent.

Example 37 includes the method of Example 36, further comprising determining the indication from the software agent based on a value of a register.

Example 38 includes the method of any of Examples 35 to 37, wherein a first map function of the two or more map functions is to promote a different access pattern for the memory as compared to a second map function of the two or more map functions.

Example 39 includes the method of Example 38, wherein the second map function is to promote cross-influence of bits of the index relative to the first map function.

Example 40 includes the method of any of Examples 38 to 39, further comprising mapping the index to the particular set based on the second map function to inject one or more bits from a lower order bitfield of an address of an access request for the memory into a higher order bitfield of the address.

Example 41 includes the method of Example 38, wherein the second map function is to promote reverse cross-influence of bits of the index relative to the first map function.

Example 42 includes the method of any of Examples 38 and 41, further comprising mapping the index to the particular set based on the second map function to inject one or more bits from a higher order bitfield of an address of an access request for the memory into a lower order bitfield of the address.

Example 43 includes a method comprising applying a map function to map an address to an associative set of a cache memory, and altering the applied map function at runtime based at least in part on an indication from a software agent.

Example 44 includes the method of Example 43, further comprising altering the applied map function at runtime to vary a portion of the address that contributes to the map of the address to the associative set of the cache memory in accordance with the indication from the software agent.

Example 45 includes the method of any of Examples 43 to 44, further comprising altering the applied map function at runtime to vary an extent that the address contributes to the map of the address to the associative set of the cache memory in accordance with the indication from the software agent.

Example 46 includes the method of any of Examples 43 to 45, further comprising altering the applied map function at runtime to promote a different access pattern for the cache memory as compared to an immediately previously applied map function.

Example 47 includes the method of any of Examples 43 to 46, further comprising altering the applied map function at runtime to vary a periodicity of an access pattern for the cache memory as compared to an immediately previously applied map function.

Example 48 includes the method of any of Examples 43 to 47, further comprising altering the applied map function at runtime to change a cross-influence between low order bitfields and higher order bitfields of the address as compared to an immediately previously applied map function.

Example 49 includes the method of any of Examples 43 to 48, further comprising determining whether the applied map function is to be altered in accordance with the indication from the software agent based on one or more of a privilege level of the software agent and stored configuration information.

Example 50 includes the method of any of Examples 43 to 49, further comprising determining the indication from the software agent based on a value of a register.

Example 51 includes an apparatus comprising a processor, memory coupled to the

processor, and circuitry coupled to the memory to expose a storage location to a software agent to indicate a request for a change in a map function for an associative set of a memory, and change a hardware map function to lookup an entry in the associative set of the memory based on a value stored in the storage location.

Example 52 includes the apparatus of Example 51, wherein the circuitry is further to select one of two or more map functions for the hardware map function based on the value stored in the storage location.

Example 53 includes the apparatus of Example 52, wherein the circuitry is further to select bits of an index for the hardware map function based on the selected one of the two or more map functions.

Example 54 includes the apparatus of any of Example 51 to 53, wherein the circuitry is further to collect data to determine performance related information for the memory.

Example 55 includes the apparatus of Example 54, wherein the circuitry is further to analyze the collected data, and determine whether to change the hardware map function based on the analysis.

Example 56 includes the apparatus of Example 55, wherein the circuitry is further to determine to change the hardware map function if the collected data shows a pattern of eviction rates above a first rate threshold and a pattern of a cacheline touch frequency above a second frequency threshold.

Example 57 includes the apparatus of any of Examples 55 to 56, wherein the circuitry is further to determine to change the hardware map function if the collected data shows statistically measured mean residencies that indicate a variation of mean residency across different associative sets of the memory in excess of a variation threshold.

Example 58 includes the apparatus of any of Examples 55 to 57, wherein the circuitry is further to determine to change the hardware map function if the collected data shows statistically measured mean residencies that indicate a variation in excess of a variation threshold for cache hit ratios normalized to a reference amount for a workload.

Example 59 includes the apparatus of any of Examples 55 to 58, wherein the circuitry is further to determine to change the hardware map function if the collected data shows statistically measured mean residencies that indicate a variation in excess of a variation threshold for access latency normalized to a reference amount for a workload.

Example 60 includes the apparatus of any of Examples 55 to 59, wherein the memory comprises one or more of a level one (L1) cache and a level two (L2), and wherein the circuitry is further to determine to change the hardware map function if the collected data shows that an application is cache bound in one of the L1 cache and the L2 cache.

Example 61 includes the apparatus of any of Examples 55 to 60, wherein the circuitry is further to notify the software agent to change the hardware map function, if so determined.

Example 62 includes the apparatus of Example 61, where in response to the notification, the software agent is further to bring a host to a barrier point, flush the memory, and provide the indication to request for the change in the map function for the associative set of the memory.

Example 63 includes a method comprising caching data with one or more cachesets, and tracking a mean residency time across the one or more cachesets.

Example 64 includes the method of Example 63, further comprising determining values for one or more of minimum residency time, maximum residency time, average residency, and standard deviation of residency time between the one or more cachesets.

Example 65 includes the method of any of Example 63 to 64, further comprising randomly selecting a cache way in each cacheset for a selected micro-epoch.

Example 66 includes the method of Example 65, further comprising tracking the mean residency time for the randomly selected way for the selected micro-epoch.

Example 67 includes the method of Example 66, further comprising setting an amount of time for the selected micro-epoch based on one of a programmable setting and a configuration setting.

Example 68. The method of any of Examples 63 to 67, further comprising sampling re-touched cachelines to identify a sequence of touches and evictions within a configurable time window for frequently touched cachelines.

Example 69 includes an apparatus comprising means for mapping an index to a particular set of one or more sets based on an indicated map function of two or more map functions, and means for looking up an entry in a memory based at least in part on the particular set indicated by the mapped index.

Example 70 includes the apparatus of Example 69, further comprising means for selecting the indicated map function based at least in part on an indication from a software agent.

Example 71 includes the apparatus of Example 70, further comprising means for determining the indication from the software agent based on a value of a register.

Example 72 includes the apparatus of any of Examples 69 to 71, wherein a first map function of the two or more map functions is to promote a different access pattern for the memory as compared to a second map function of the two or more map functions.

Example 73 includes the apparatus of Example 72, wherein the second map function is to promote cross-influence of bits of the index relative to the first map function.

Example 74 includes the apparatus of any of Examples 72 to 73, further comprising means for mapping the index to the particular set based on the second map function to inject one or more bits from a lower order bitfield of an address of an access request for the memory into a higher order bitfield of the address.

Example 75 includes the apparatus of Example 72, wherein the second map function is to promote reverse cross-influence of bits of the index relative to the first map function.

Example 76 includes the apparatus of any of Examples 72 and 75, further comprising means for mapping the index to the particular set based on the second map function to inject one or more bits from a higher order bitfield of an address of an access request for the memory into a lower order bitfield of the address.

Example 77 includes an apparatus comprising means for applying a map function to map an address to an associative set of a cache memory, and means for altering the applied map function at runtime based at least in part on an indication from a software agent.

Example 78 includes the apparatus of Example 77, further comprising means for altering the applied map function at runtime to vary a portion of the address that contributes to the map of the address to the associative set of the cache memory in accordance with the indication from the software agent.

Example 79 includes the apparatus of any of Examples 77 to 78, further comprising means for altering the applied map function at runtime to vary an extent that the address contributes to the map of the address to the associative set of the cache memory in accordance with the indication from the software agent.

Example 80 includes the apparatus of any of Examples 77 to 79, further comprising means for altering the applied map function at runtime to promote a different access pattern for the cache memory as compared to an immediately previously applied map function.

Example 81 includes the apparatus of any of Examples 77 to 80, further comprising means for altering the applied map function at runtime to vary a periodicity of an access pattern for the cache memory as compared to an immediately previously applied map function.

Example 82 includes the apparatus of any of Examples 77 to 81, further comprising means for altering the applied map function at runtime to change a cross-influence between low order bitfields and higher order bitfields of the address as compared to an immediately previously applied map function.

Example 83 includes the apparatus of any of Examples 77 to 82, further comprising means for determining whether the applied map function is to be altered in accordance with the indication from the software agent based on one or more of a privilege level of the software agent and stored configuration information.

Example 84 includes the apparatus of any of Examples 77 to 83, further comprising means for determining the indication from the software agent based on a value of a register.

Example 85 includes an apparatus comprising means for exposing a setting to a software agent to indicate a request for a change in a mapping function for an associative set of a memory, and means for changing a hardware mapping function for looking up an entry in the associative set of the memory based on the exposed setting.

Example 86 includes the apparatus of Example 85, further comprising means for selecting one of two or more mapping functions for the hardware mapping function based on the exposed setting.

Example 87 includes the apparatus of Example 86, further comprising means for selecting bits of an index for the hardware mapping function based on the selected one of the two or more mapping functions.

Example 88 includes the apparatus of any of Examples 85 to 87, further comprising means for collecting data to determine performance related information for the memory.

Example 89 includes the apparatus of Example 88, further comprising means for analyzing the collected data, and means for determining whether to change the hardware mapping function based on the analysis.

Example 90 includes the apparatus of Example 89, further comprising means for determining to change the hardware mapping function if the collected data shows a pattern of eviction rates above a first rate threshold and a pattern of a cacheline touch frequency above a second frequency threshold.

Example 91 includes the apparatus of any of Examples 89 to 90, further comprising means for determining to change the hardware mapping function if the collected data shows statistically measured mean residencies that indicate a variation of mean residency across different associative sets of the memory in excess of a variation threshold.

Example 92 includes the apparatus of any of Examples 89 to 91, further comprising means for determining to change the hardware mapping function if the collected data shows statistically measured mean residencies that indicate a variation in excess of a variation threshold for cache hit ratios normalized to a reference amount for a workload.

Example 93 includes the apparatus of any of Examples 89 to 92, further comprising means for change the hardware mapping function if the collected data shows statistically measured mean residencies that indicate a variation in excess of a variation threshold for access latency normalized to a reference amount for a workload.

Example 94 includes the apparatus of any of Examples 89 to 93, wherein the memory comprises one or more of a level one (L1) cache and a level two (L2), further comprising means for determining to change the hardware mapping function if the collected data shows that an application is cache bound in one of the L1 cache and the L2 cache.

Example 95 includes the apparatus of any of Examples 89 to 94, further comprising means for notifying the software agent to change the hardware mapping function, if so determined.

Example 96 includes the apparatus of Example 95, further comprising, by the software agent in response to the notification means for bringing a host to a barrier point, means for flushing the memory, and means for providing the indication to request for the change in the mapping function for the associative set of the memory.

Example 97 includes an apparatus comprising means for caching data with one or more cachesets, and means for tracking a mean residency time across the one or more cachesets.

Example 98 includes the apparatus of Example 97, further comprising means for determining values for one or more of minimum residency time, maximum residency time, average residency, and standard deviation of residency time between the one or more cachesets.

Example 99 includes the apparatus of any of Example 97 to 98, further comprising means for randomly selecting a cache way in each cacheset for a selected micro-epoch.

Example 100 includes the apparatus of Example 99, further comprising means for tracking the mean residency time for the randomly selected way for the selected micro-epoch.

Example 101 includes the apparatus of Example 100, further comprising means for setting an amount of time for the selected micro-epoch based on one of a programmable setting and a configuration setting.

Example 102 includes the apparatus of any of Examples 97 to 101, further comprising means for sampling re-touched cachelines to identify a sequence of touches and evictions within a configurable time window for frequently touched cachelines.

Example 103 includes at least one non-transitory one machine readable medium comprising a plurality of instructions that, in response to being executed on a computing device, cause the computing device to map an index to a particular set of one or more sets based on an indicated map function of two or more map functions, and look up an entry in a memory based at least in part on the particular set indicated by the mapped index.

Example 104 includes the at least one non-transitory one machine readable medium of Example 103, comprising a plurality of further instructions that, in response to being executed on the computing device, cause the computing device to select the indicated map function based at least in part on an indication from a software agent.

Example 105 includes the at least one non-transitory one machine readable medium of Example 104, comprising a plurality of further instructions that, in response to being executed on the computing device, cause the computing device to determine the indication from the software agent based on a value of a register.

Example 106 includes the at least one non-transitory one machine readable medium of any of Examples 103 to 105, wherein a first map function of the two or more map functions is to promote a different access pattern for the memory as compared to a second map function of the two or more map functions.

Example 107 includes the at least one non-transitory one machine readable medium of Example 106, wherein the second map function is to promote cross-influence of bits of the index relative to the first map function.

Example 108 includes the at least one non-transitory one machine readable medium of any of Examples 106 to 107, comprising a plurality of further instructions that, in response to being executed on the computing device, cause the computing device to map the index to the particular set based on the second map function to inject one or more bits from a lower order bitfield of an address of an access request for the memory into a higher order bitfield of the address.

Example 109 includes the at least one non-transitory one machine readable medium of Example 106, wherein the second map function is to promote reverse cross-influence of bits of the index relative to the first map function.

Example 110 includes the at least one non-transitory one machine readable medium of any of Examples 106 to 109, comprising a plurality of further instructions that, in response to being executed on the computing device, cause the computing device to map the index to the particular set based on the second map function to inject one or more bits from a higher order bitfield of an address of an access request for the memory into a lower order bitfield of the address.

Example 111 includes at least one non-transitory one machine readable medium comprising a plurality of instructions that, in response to being executed on a computing device, cause the computing device to apply a map function to map an address to an associative set of a cache memory, and alter the applied map function at runtime based at least in part on an indication from a software agent.

Example 112 includes the at least one non-transitory one machine readable medium of Example 111, comprising a plurality of further instructions that, in response to being executed on the computing device, cause the computing device to alter the applied map function at runtime to vary a portion of the address that contributes to the map of the address to the associative set of the cache memory in accordance with the indication from the software agent.

Example 113 includes the at least one non-transitory one machine readable medium of any of Examples 111 to 112, comprising a plurality of further instructions that, in response to being executed on the computing device, cause the computing device to alter the applied map function at runtime to vary an extent that the address contributes to the map of the address to the associative set of the cache memory in accordance with the indication from the software agent.

Example 114 includes the at least one non-transitory one machine readable medium of any of Examples 111 to 113, comprising a plurality of further instructions that, in response to being executed on the computing device, cause the computing device to alter the applied map function at runtime to promote a different access pattern for the cache memory as compared to an immediately previously applied map function.

Example 115 includes the at least one non-transitory one machine readable medium of any of Examples 111 to 114, comprising a plurality of further instructions that, in response to being executed on the computing device, cause the computing device to alter the applied map function at runtime to vary a periodicity of an access pattern for the cache memory as compared to an immediately previously applied map function.

Example 116 includes the at least one non-transitory one machine readable medium of any of Examples 111 to 115, comprising a plurality of further instructions that, in response to being executed on the computing device, cause the computing device to alter the applied map function at runtime to change a cross-influence between low order bitfields and higher order bitfields of the address as compared to an immediately previously applied map function.

Example 117 includes the at least one non-transitory one machine readable medium of any of Examples 111 to 116, comprising a plurality of further instructions that, in response to being executed on the computing device, cause the computing device to determine whether the applied map function is to be altered in accordance with the indication from the software agent based on one or more of a privilege level of the software agent and stored configuration information.

Example 118 includes the at least one non-transitory one machine readable medium of any of Examples 111 to 117, comprising a plurality of further instructions that, in response to being executed on the computing device, cause the computing device to determine the indication from the software agent based on a value of a register.

Example 119 includes at least one non-transitory one machine readable medium comprising a plurality of instructions that, in response to being executed on a computing device, cause the computing device to expose a setting to a software agent to indicate a request for a change in a map function for an associative set of a memory, and change a hardware map function to look up an entry in the associative set of the memory based on the exposed setting.

Example 120 includes the at least one non-transitory one machine readable medium of Example 119, comprising a plurality of further instructions that, in response to being executed on the computing device, cause the computing device to select one of two or more map functions for the hardware map function based on the exposed setting.

Example 121 includes the at least one non-transitory one machine readable medium of Example 120, comprising a plurality of further instructions that, in response to being executed on the computing device, cause the computing device to select bits of an index for the hardware map function based on the selected one of the two or more map functions.

Example 122 includes the at least one non-transitory one machine readable medium of any of Examples 119 to 121, comprising a plurality of further instructions that, in response to being executed on the computing device, cause the computing device to collect data to determine performance related information for the memory.

Example 123 includes the at least one non-transitory one machine readable medium of Example 122, comprising a plurality of further instructions that, in response to being executed on the computing device, cause the computing device to analyze the collected data, and determine whether to change the hardware map function based on the analysis.

Example 124 includes the at least one non-transitory one machine readable medium of Example 123, comprising a plurality of further instructions that, in response to being executed on the computing device, cause the computing device to determine to change the hardware map function if the collected data shows a pattern of eviction rates above a first rate threshold and a pattern of a cacheline touch frequency above a second frequency threshold.

Example 125 includes the at least one non-transitory one machine readable medium of any of Examples 123 to 124, comprising a plurality of further instructions that, in response to being executed on the computing device, cause the computing device to determine to change the hardware map function if the collected data shows statistically measured mean residencies that indicate a variation of mean residency across different associative sets of the memory in excess of a variation threshold.

Example 126 includes the at least one non-transitory one machine readable medium of any of Examples 123 to 125, comprising a plurality of further instructions that, in response to being executed on the computing device, cause the computing device to determine to change the hardware map function if the collected data shows statistically measured mean residencies that indicate a variation in excess of a variation threshold for cache hit ratios normalized to a reference amount for a workload.

Example 127 includes the at least one non-transitory one machine readable medium of any of Examples 123 to 126, comprising a plurality of further instructions that, in response to being executed on the computing device, cause the computing device to determine to change the hardware map function if the collected data shows statistically measured mean residencies that indicate a variation in excess of a variation threshold for access latency normalized to a reference amount for a workload.

Example 128 includes the at least one non-transitory one machine readable medium of any of Examples 123 to 127, wherein the memory comprises one or more of a level one (L1) cache and a level two (L2), comprising a plurality of further instructions that, in response to being executed on the computing device, cause the computing device to determine to change the hardware map function if the collected data shows that an application is cache bound in one of the L1 cache and the L2 cache.

Example 129 includes the at least one non-transitory one machine readable medium of any of Examples 123 to 128, comprising a plurality of further instructions that, in response to being executed on the computing device, cause the computing device to notify the software agent to change the hardware map function, if so determined.

Example 130 includes the at least one non-transitory one machine readable medium of Example 129, comprising a plurality of further instructions that, in response to being executed on the computing device, cause the computing device to bring a host to a barrier point, flush the memory, and provide the indication to request for the change in the map function for the associative set of the memory.

Example 131 includes at least one non-transitory one machine readable medium comprising a plurality of instructions that, in response to being executed on a computing device, cause the computing device to cache data with one or more cachesets, and track a mean residency time across the one or more cachesets.

Example 132 includes the at least one non-transitory one machine readable medium of Example 131, comprising a plurality of further instructions that, in response to being executed on the computing device, cause the computing device to determine values for one or more of minimum residency time, maximum residency time, average residency, and standard deviation of residency time between the one or more cachesets.

Example 133 includes the at least one non-transitory one machine readable medium of any of Examples 131 to 132, comprising a plurality of further instructions that, in response to being executed on the computing device, cause the computing device to randomly select a cache way in each cacheset for a selected micro-epoch.

Example 134 includes the at least one non-transitory one machine readable medium of Example 133, comprising a plurality of further instructions that, in response to being executed on the computing device, cause the computing device to track the mean residency time for the randomly selected way for the selected micro-epoch.

Example 135 includes the at least one non-transitory one machine readable medium of Example 134, comprising a plurality of further instructions that, in response to being executed on the computing device, cause the computing device to set an amount of time for the selected micro-epoch based on one of a programmable setting and a configuration setting.

Example 136 includes the at least one non-transitory one machine readable medium of any of Examples 131 to 135, comprising a plurality of further instructions that, in response to being executed on the computing device, cause the computing device to sample re-touched cachelines to identify a sequence of touches and evictions within a configurable time window for frequently touched cachelines.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMS, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain examples are not described with reference to any particular programming language. It will be appreciated that a variety of programming languages may be used to implement the teachings of such examples as described herein.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

1-25. (canceled)

26. An apparatus comprising:
a memory; and
circuitry coupled to the memory to:
map an index to a particular set of one or more sets based on an indicated map function of two or more map functions, and
lookup an entry in the memory based at least in part on the particular set indicated by the mapped index.

27. The apparatus of claim 26, wherein the circuitry is further to:
select the indicated map function based at least in part on an indication from a software agent.

28. The apparatus of claim 27, wherein the circuitry is further to:
determine the indication from the software agent based on a value of a register.

29. The apparatus of claim 26, wherein a first map function of the two or more map functions is to promote a different access pattern for the memory as compared to a second map function of the two or more map functions.

30. The apparatus of claim 29, wherein the second map function is to promote cross-influence of bits of the index relative to the first map function.

31. The apparatus of claim 29, wherein the circuitry is further to:
map the index to the particular set based on the second map function to inject one or more bits from a lower order bitfield of an address of an access request for the memory into a higher order bitfield of the address.

32. The apparatus of claim 29, wherein the second map function is to promote reverse cross-influence of bits of the index relative to the first map function.

33. The apparatus of claim 29, wherein the circuitry is further to:
map the index to the particular set based on the second map function to inject one or more bits from a higher order bitfield of an address of an access request for the memory into a lower order bitfield of the address.

34. An apparatus comprising:
a processor;
a cache memory coupled to the processor; and
circuitry coupled to the cache memory to:
apply a map function to map an address to an associative set of the cache memory, and
alter the applied map function at runtime based at least in part on an indication from a software agent.

35. The apparatus of claim 34, wherein the circuitry is further to:
alter the applied map function at runtime to vary a portion of the address that contributes to the map of the address to the associative set of the cache memory in accordance with the indication from the software agent.

36. The apparatus of claim 34, wherein the circuitry is further to:
alter the applied map function at runtime to vary an extent that the address contributes to the map of the address to the associative set of the cache memory in accordance with the indication from the software agent.

37. The apparatus of claim 34, wherein the circuitry is further to:
alter the applied map function at runtime to promote a different access pattern for the cache memory as compared to an immediately previously applied map function.

38. The apparatus of claim 34, wherein the circuitry is further to:
alter the applied map function at runtime to vary a periodicity of an access pattern for the cache memory as compared to an immediately previously applied map function.

39. The apparatus of claim 34, wherein the circuitry is further to:
alter the applied map function at runtime to change a cross-influence between low order bitfields and higher order bitfields of the address as compared to an immediately previously applied map function.

40. The apparatus of claim 34, wherein the circuitry is further to:
determine whether the applied map function is to be altered in accordance with the indication from the software agent based on one or more of a privilege level of the software agent and stored configuration information.

41. A method comprising:
exposing a setting to a software agent to indicate a request for a change in a mapping function for an associative set of a memory; and
changing a hardware mapping function for looking up an entry in the associative set of the memory based on the exposed setting.

42. The method of claim 41, further comprising:
selecting one of two or more mapping functions for the hardware mapping function based on the exposed setting.

43. The method of claim 42, further comprising:
selecting bits of an index for the hardware mapping function based on the selected one of the two or more mapping functions.

44. The method of claim 41, further comprising:
collecting data to determine performance related information for the memory.

45. The method of claim 44, further comprising:
analyzing the collected data; and
determining whether to change the hardware mapping function based on the analysis.
